(19) United States
(12) Patent Application Publication
(10) Pub. No.: US 2025/0333631 A1
(43) Pub. Date: Oct. 30, 2025

(54) METAL-ORGANIC FRAMEWORK AS A MATRIX FOR POLYETHYLENE GLYCOL IN THERMAL ENERGY STORAGE AND PREPARATIONS THEREOF

(71) Applicant: King Fahd University of Petroleum and Minerals, Dhahran (SA)

(72) Inventors: Md. Hasan ZAHIR, Dhahran (SA); Aasif HELAL, Dhahran (SA); Kashif IRSHED, Dhahran (SA); Amjad ALI, Dhahran (SA)

(73) Assignee: King Fahd University of Petroleum and Minerals, Dhahran (SA)

(21) Appl. No.: 18/651,469

(22) Filed: Apr. 30, 2024

(51) Int. Cl. C09K 5/06; C08J 5/18; C08K 5/098; F24S 60/10; F24S 70/12

(52) U.S. Cl. CPC C09K 5/063; C08J 5/18; C08K 5/098; F24S 60/10; F24S 70/12; C08J 2371/02; C08K 2201/001; C08K 2201/006

(57) ABSTRACT

The present disclosure is directed to a phase-change material (PCM) including a metal selected from cobalt and nickel and reacted units of 1,3,5-benzenetricarboxylic acid (BTC) for thermal energy storage and method of preparation thereof. The metal and the reacted units of the carboxylic acid form a metal-organic framework (MOF). The PCM further includes polyethylene glycol (PEG) present within a matrix of the MOF with a weight ratio of the metal organic framework to the polyethylene glycol from 10:1 to 1:10. The PCM of the present disclosure is in the form of agglomerated layers of wave-like sheets.

### STATEMENT OF ACKNOWLEDGEMENT

Support provided by the Deanship of Research Oversight and Coordination (DROC) at King Fahd University of Petroleum and Minerals (KFUPM), Saudi Arabia is gratefully acknowledged.

### BACKGROUND

### Technical Field

The present disclosure is directed to a phase change material, and more particularly to a polyethylene glycol (PEG)-based composite phase change material (PCM) in a metal-benzene tricarboxylic acid (BTC) matrix for thermal energy storage.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The development of thermal energy storage systems based on phase-change materials (PCMs) has gained attention in the renewable energy sector. Polyethylene glycol (PEG) has been investigated as an organic PCM due to its favorable properties, such as suitable melting temperatures, chemical characteristics, low vapor pressures, non-toxicity, durability against erosion, and reasonable pricing; however, PEG faces two challenges when applied as a PCM: (i) poor heat conductivity and (ii) potential leakage during the liquification energy storage cycle. These challenges can be addressed by containing PEG within a metal or alloy container; however, the encapsulation of PEG in a metal container is not conducive to supercooling cycles. To overcome these challenges, shape-stabilized PCMs (ss-PCMs), which utilize inorganic and/or porous metal-organic frameworks (MOFs) as support matrices, have been developed. The selection of an appropriate support matrix offers several appealing qualities, including a porous structure, distinct sorption capabilities, improved thermal conductivity, flame retardancy, thermal stability, and chemical stability.

Metal-organic frameworks (MOFs) have garnered attention due to their wide range of potential uses. By establishing bonds between metal ions (M⁺) and polyfunctional carbon-based molecules (L), a tunable porous matrix can be created. These porous MOFs can be functionalized and utilized in various applications, such as selective separations, gas purification/adsorption, catalysis, guest exchange, electrochemical applications, medication distribution, and thermal energy storage. There have been attempts to combine polymers with metal-organic frameworks (MOFs) to produce polymer-MOF hybrid materials that possess both the high crystallinity and tunability of MOFs, as well as the processability and stability of polymers. Phase transition temperatures of fatty acids fall within the range of typical human applications; therefore, fatty acids are also useful for applications such as building materials, thermo-regulated fabrics, and furniture due to their energy storage density and acceptable phase change temperature.

A PCM@MOF composite material for thermal energy storage utilized the high pore volume, high surface area, and adjustable nature of the MOF to create shape-stabilized phase change materials [Y. Luan, Y. Qi, H. Gao, R.S. Andriamitantsoa, N. Zheng, G. Wang, A general post- synthetic modification approach of amino-tagged metal-organic frameworks to access efficient catalysts for the Knoevenagel condensation reaction. J. Mater. Chem. A, 3 (2015) 17320-17331]. The highest achieved latent heat among fatty acid@heterogeneous support (Cr-MIL-101-NH₂) shape-stabilized PCM composites is 120.53 J/g. MOFs are anticipated to resolve issues associated with PCMs, such as uncontrolled volume expansion, leakage, and incompatibility with nonpolar surfaces [D. Feng, Y. Feng, Y. Zang, P. Li, X. Zhang, Phase change in modified metal-organic frameworks MIL-101 (Cr): Mechanism on highly improved energy storage performance. Microporous Mesoporous Mater. 280 (2019) 124-132]. The high specific surface area and large pore volume, which are controllable features of transition metal-based MOFs, make them attractive candidates as support matrices for shape-stabilized PCMs. Surprisingly, despite their significant promise in this application, there are relatively few studies reporting on the usage of MOFs in PCMs.

Nickel-based MOFs have been used in a wide range of applications due to their low price and the abundant availability of nickel worldwide. Generally, nickel-based MOFs are considered for use in electrodes, supercapacitors, hydrogen storage, and energy storage strategies [A. Helal, M. Naeem, M.E. Arafat, M.M. Rahman, Europium doped Ni (BTC) metal-organic framework for detection of heteroaromatic compounds in mixed aqueous media, Materials Research Bulletin, 146 (2022) 111604]. Cobalt-based MOFs ((Co-BTC) MOFs) have been explored for CO₂ conversion (BTC: 1,3,5-benzene tricarboxylic acid) [R.D. McGillicuddy, S. Thapa, M.B. Wenny, M.I. Gonzalez, J.A. Mason, Metal-organic phase change materials for thermal energy storage, Journal of the American Chemical Society. 142 (2020) 19170-19180].

Considering the advantages of MOFs, a new class of MOF-based PCMs for solar-thermal storage applications has been studied. Recently, a combination of UiO-66 MOFs and PEG (polyethylene glycol) hybrid materials have been prepared, which demonstrated good performance in terms of high solar-thermal energy capacity and promising PCM properties [F. Tian, C. Qiao, R. Zheng, Q. Ru, X. Sun, Y. Zhang, C. Meng, Synthesis of bimetallic organic framework Cu/Co-BTC and the improved performance of thiophene adsorption, RSC Advances. 9 (2019) 15642-15647]. The design of materials that can reversibly store highly concentrated solar-thermal energy is considered for efficient and sustainable utilization of solar energy. 3D permeable (3,6)-connected MOFs that incorporate PEG resulted in a composite PCM with good latent heat and thermal stability in repeated cycles [D.G. Atinafu, S.J. Chang, K.H. Kim, W. Dong, S. Kim, A novel enhancement of shape/thermal stability and energy-storage capacity of phase change materials through the formation of composites with 3D porous (3,6)-connected metal-organic framework, Chemical Engineering Journal. 389 (2020) 124430].

Although a few metal organic-based PCMs have been reported in the past, most of the conventional metal organic-based PCMs suffer from challenges, such as complex preparation processes and difficult pore regulation. Therefore, more promising porous supporting materials with simple preparation processes and easy tunable pore regulation are sought for thermal energy storage. Accordingly, an object of the present disclosure is to provide a phase change material for thermal energy storage that overcomes shortcomings of known phase change materials.

### SUMMARY

In an exemplary embodiment, a phase change material (PCM) is described. The PCM includes a metal selected from a group consisting of cobalt and nickel and reacted units of 1,3,5-benzene tricarboxylic acid. The metal and the reacted units of the carboxylic acid form a metal-organic framework. The PCM further includes polyethylene glycol that is present within a matrix of the metal-organic framework. A weight ratio of the metal organic framework to the polyethylene glycol is from 10:1 to 1:10. The phase-change material is in the form of agglomerated layers of wave-like sheets.

In some embodiments, the polyethylene glycol is polyethylene glycol 6000.

In some embodiments, the agglomerated layers of wave-like sheets have micro cracks with a length of 1 to 50 μm. The agglomerated layers of wave-like sheets have one or more flaked edges.

In some embodiments, 60 to 90 wt. % of the polyethylene glycol is present in the matrix of the metal-organic framework based on a total weight of the polyethylene glycol in the phase change material.

In some embodiments, the metal-organic framework includes carbon in an amount of 50 to 70 atomic percent, oxygen in an amount of 25 to 45 atomic percent, and the metal in an amount of 1 to 5 atomic percent based on a total atom count of the metal-organic framework.

In some embodiments, the metal is cobalt, and the metal-organic framework has a Brunauer-Emmett-Teller specific surface area of 250 to 350 m²/g.

In some embodiments, the metal is nickel, and the metal-organic framework has a Brunauer-Emmett-Teller specific surface area of 800 to 900 m²/g.

In some embodiments, the metal is cobalt and nickel and the metal-organic framework has a Brunauer-Emmett-Teller specific surface area of 550 to 650 m²/g.

In some embodiments, the metal is cobalt, and the metal-organic framework has a micropore volume of 0.7000 to 0.7500 cm²/g.

In some embodiments, the metal is nickel, and the metal-organic framework has a micropore volume of 0.2500 to 0.3000 cm²/g.

In some embodiments, the metal is cobalt and nickel and the metal-organic framework has a micropore volume of 0.2000 to 0.2500 cm²/g.

In some embodiments, the phase-change material has a thermal stability of 200 to 400° C. based on thermogravimetric analysis.

In some embodiments, the metal is nickel and the phase-change material has a melting latent heat value of 150 to 160 J/g.

In some embodiments, the metal is nickel, and the phase-change material has a freezing latent heat value of 125 to 140 J/g.

In some embodiments, the metal is cobalt, and the phase-change material has a melting latent heat value of 135 to 140 J/g.

In some embodiments, the metal is nickel, and the metal-organic framework has a solar-to-thermal energy storage efficiency of 70 to 75 percent.

In some embodiments, the metal is nickel and the phase-change material has a thermal stability of at least 200 differential scanning calorimetry melting and freezing cycles. The thermal stability is based on a solar-to-thermal conversion value and the solar-to-thermal conversion value is 0.5 to 1.0 percent less than an initial solar-to-thermal conversion value.

In some embodiments, the phase-change material has a super cooling value of 18 to 23° C.

In some embodiments, the phase-change material has a thermal conductivity of 0.2200 to 0.3500 W m⁻¹ K⁻¹.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternative and/or variations thereof) and many of the attendant advantages thereof will be readily obtained as the same becomes better understood by reference to the following detailed description when considered in connection with the accompanying drawings, wherein:

FIG. 1A is a flow chart depicting a method of preparing a metal-organic framework (MOF) of cobalt-1,3,5 benzene tricarboxylic acid (Co-BTC), according to certain embodiments;

FIG. 1B is a flow chart depicting a method of preparing a MOF of nickel-1,3,5 benzene tricarboxylic acid (Ni-BTC), according to certain embodiments;

FIG. 1C is a flow chart depicting a method of preparing a MOF of cobalt-and-nickel-1,3,5 benzene tricarboxylic acid (Co—Ni-BTC), according to certain embodiments;

FIG. 1D is a flow chart depicting a method of preparing a composite phase change material (PCM) of polyethylene glycol (PEG) with Ni-BTC, Co-BTC, and Co—Ni-BTC, according to certain embodiments;

FIG. 2 depicts X-ray diffraction (XRD) patterns of Co-BTC, Ni-BTC, and Co—Ni-BTC, according to certain embodiments;

FIG. 3 shows XRD patterns of Co-BTC/PEG, Ni-BTC/PEG, and Co—Ni-BTC/PEG with varying MOF to PEG ratios, according to certain embodiments;

FIG. 4 shows Fourier-transform infrared spectra (FTIR) of Ni-BTC, Co-BTC, and Co—Ni-BTC, according to certain embodiments;

FIG. 5 shows FTIR spectra of PEG-6000, Ni-BTC/PEG, Co-BTC/PEG, and Co—Ni-BTC/PEG with varying MOF to PEG ratios, according to certain embodiments;

FIG. 6A shows a field emission scanning electron microscopy (FESEM) image of Co-BTC, according to certain embodiments;

FIG. 6B shows an FESEM image of Ni-BTC, according to certain embodiments;

FIG. 6C shows an FESEM image of Co—Ni-BTC, according to certain embodiments;

FIG. 6D shows an FESEM image of Co-BTC/PEG, according to certain embodiments;

FIG. 6E shows an FESEM image of Ni-BTC/PEG, according to certain embodiments;

FIG. 6F shows an FESEM image of Co—Ni-BTC/PEG, according to certain embodiments;

FIG. 7A shows an energy dispersive spectroscopy (EDS) spectrum of Ni-BTC, according to certain embodiments;

FIGS. 7B-7D depict scanning electron microscope (SEM) images and corresponding EDS elemental mapping of carbon, nitrogen, and nickel, respectively, of Ni-BTC, according to certain embodiments;

FIG. 8A shows an EDS spectrum of Co-BTC, according to certain embodiments;

FIGS. 8B-8D depict SEM images and corresponding EDS elemental mapping of carbon, oxygen, and cobalt, respectively, of Co-BTC, according to certain embodiments;

FIG. 9A shows an EDS spectrum of Co—Ni-BTC, according to certain embodiments;

FIGS. 9B-9E show SEM images and corresponding EDS elemental mapping of carbon, oxygen, cobalt, and nickel, respectively, of Co—Ni-BTC, according to certain embodiments;

FIG. 10A shows N₂ adsorption-desorption isotherm of Co-BTC, according to certain embodiments;

FIG. 10B shows N₂ adsorption-desorption isotherm of Ni-BTC, according to certain embodiments;

FIG. 10C shows N₂ adsorption-desorption isotherms of Co—Ni-BTC, according to certain embodiments;

FIG. 10D shows pore size distribution of Co-BTC, according to certain embodiments;

FIG. 10E shows pore size distribution of Ni-BTC, according to certain embodiments;

FIG. 10F shows pore size distribution of Co—Ni-BTC, according to certain embodiments;

FIG. 11A shows X-ray photoelectron spectroscopy (XPS) survey spectrum of Ni-BTC, according to certain embodiments;

FIG. 11B shows XPS high resolution spectrum of O1s region of Ni-BTC, according to certain embodiments;

FIG. 11C shows XPS high resolution spectrum of C1s region of Ni-BTC, according to certain embodiments;

FIG. 12 shows thermogravimetric analysis (TGA) curves of Ni-BTC/PEG, PEG-6000, Co-BTC/PEG, and Co—Ni-BTC/PEG, according to certain embodiments;

FIG. 13A shows melting-freezing differential scanning calorimetry (DSC) curves of Co-BTC/PEG (0.2:0.5) PCM composite, according to certain embodiments;

FIG. 13B shows melting-freezing DSC curves of Co-BTC/PEG (0.2:0.7) PCM composite, according to certain embodiments;

FIG. 13C shows melting-freezing DSC curves of Co-BTC/PEG (0.2:1.0) PCM composite, according to certain embodiments;

FIG. 14A shows melting-freezing DSC curves of Ni-BTC/PEG (0.2:0.5) PCM composite, according to certain embodiments;

FIG. 14B shows melting-freezing DSC curves of Ni-BTC/PEG (0.2:0.7) PCM composite, according to certain embodiments;

FIG. 14C shows melting-freezing DSC curves of Ni-BTC/PEG (0.2:1.0) PCM composite, according to certain embodiments;

FIG. 15A shows melting-freezing DSC curves for Co—Ni-BTC/PEG (0.2:0.5) PCM composite, according to certain embodiments;

FIG. 15B shows melting-freezing DSC curves for Co—Ni-BTC/PEG (0.2:0.7) PCM composite, according to certain embodiments;

FIG. 15C shows melting-freezing DSC curves for Co—Ni-BTC/PEG (0.2:1.0) PCM composite, according to certain embodiments;

FIG. 16A shows 200 cycles of DSC melting-freezing cycling curves for Ni-BTC/PEG PCM composite, according to certain embodiments;

FIG. 16B shows an SEM image of the Ni-BTC/PEG PCM composite after 200 cycles of DSC melting-freezing, according to certain embodiments.

FIG. 17 shows images of PEG, Ni-BTC/PEG, Co-BTC/PEG, and Co—Ni-BTC/PEG compressed into a disk of 20 mm diameter and placed on a laboratory heating platform at 30° C. and 80°° C., according to certain embodiments;

FIG. 18A shows light-to-thermal energy conversion curves of PEG, Co-BTC/PEG, Ni-BTC/PEG, and Co—Ni-BTC/PEG composites under solar simulator irradiation (I=120 mW cm⁻²), according to certain embodiments;

FIG. 18B shows solar-to-thermal energy conversion curves of PEG, Co-BTC/PEG, Ni-BTC/PEG, and Co—Ni-BTC/PEG composites under sunlight irradiation (I=98 mW cm⁻²), according to certain embodiments;

FIG. 19A shows a heating temperature curve of Ni-BTC/PEG, according to certain embodiments; and

FIG. 19B shows freezing temperature curves of Ni-BTC/PEG, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Unless otherwise noted, the present disclosure is intended to include all isotopes of the samples used herein.

As used herein, mesopores refer to pores with a diameter of 2 to 50 nanometers (nm) and micropores refer to pores with a diameter of less than or equal to 2 nm.

Aspects of the present disclosure are directed to cobalt, nickel, and cobalt-nickel-doped 1,3,5-benzene tricarboxylic acid (BTC) metal organic frameworks (MOFs) for use as an efficient matrix for polyethylene glycol (PEG)-based phase-change materials (PCMs) for solar-thermal energy storage. Three metal-oxide-doped BTC/PEG systems, namely, Ni-BTC/PEG, Co-BTC/PEG, and Co—Ni-BTC/PEG, were prepared by a hydrothermal technique using low-cost materials. Among the three metal-oxide-doped BTC/PEG systems, Ni-BTC/PEG showed the best performance for energy storage, with a latent heat value of 156 J/g and a supercooling value of 19.0. Additionally, the recyclability results of this material displayed a very low supercooling value. Overall, the Ni-BTC/PEG PCM maintained its capability to store and supply energy even after repeated thermal heating and cooling cycles.

A phase composite material (PCM) is described. The PCM includes a metal-organic framework (MOF) of a metal selected from a group of cobalt, nickel, and a combination thereof. In an embodiment, the metal is nickel. In an embodiment, the metal is cobalt. In an embodiment, the metal is a combination of nickel and cobalt. In an embodiment, the MOF is prepared by reacting the metal with a linker. In a preferred embodiment, the linker is 1,3,5-benzene tricarboxylic acid (BTC).

The PCM further includes polyethylene glycol (PEG). In some embodiments, the PEG is PEG 400, PEG 1500, PEG 3350, PEG 4000, PEG 6000, PEG 8000, the like, and/or combinations thereof. In a preferred embodiment, the PEG is PEG 6000. The PEG may have a weight average molecular weight of 1,000-10,000, preferably 2,000-8,000, 3,000-7,000 or 5,000-6,000. The PEG is present in the matrix of the MOF. The matrix of the MOF may be porous. In some embodiments, about 60 to 90 wt. %, preferably 65 to 85 wt. %, and preferably 70 to 80 wt. % of the PEG is present in the matrix of the MOF based on an initial weight of the PEG. In some embodiments, the PEG may penetrate the porous matrix of the MOF. In some embodiments, the PEG may partially and/or wholly cover the MOF. In some embodiments, the PEG may penetrate the porous matrix of the MOF and cover the MOF. In some embodiments, the PEG may be present in the porous matrix of the MOF and bond to the MOF through electrostatic interactions and any other interactions known in the art. The weight ratio of MOF to PEG in the PCM is in the range of 10:1 to 1:10, preferably 9:1 to 1:9, preferably 8:1 to 1:8, preferably 7:1 to 1:7, preferably 6:1 to 1:6, preferably 5:1 to 1:5, preferably 4:1 to 1:4, preferably 3:1 to 1:3, more preferably 2:1 to 1:2, and yet more preferably about 1:1.

The PCM is in the form of agglomerated layers of wave-like sheets. In some embodiments, the agglomerated layers of wave-like sheets have irregular surfaces defined by longest dimensions of 5 to 100 μm, preferably 10 to 80 μm, and more preferably 20 to 40 μm, with projections having a height of 1 to 20 μm, preferably 2 to 15 μm, and more preferably 5 to 10 μm out of a plane of the surface of the PCM. In some embodiments, the wave-like structure include agglomerated layers of multi-layer sheets representing vertically oriented projections of layers, and flat surfaces of single layers generally orthogonal to the vertically oriented projections. In some embodiments, the vertically orientated projections of layers and flat surfaces of a single layer have a surface area ratio of 1:10 to 10:1, preferably 1:8 to 8:1, preferably 1:5 to 5:1, more preferably 1:3 to 3:1, and yet more preferably about 1:1 based on a total surface area of the phase change material. In some embodiments, the vertically orientated projections of layers may be 1 to 50 layers, preferably 2 to 25 layers, more preferably 5 to 20 layers, and yet more preferably 10 to 15 layers. In some embodiments, the agglomerated layers of wave-like sheets have microcracks with a length of 1 to 50 μm, preferably with a length of 5 to 45 μm, preferably with a length of 10 to 40 μm, more preferably with a length of 15 to 35 μm, and yet more preferably with a length of 20 to 30 μm. In some embodiments, the agglomerated layers of wave-like sheets have one or more flaked edges. In some embodiments, the agglomerated layers of wave-like sheets may have dispersed particles in and/or on the agglomerated layers of wave-like sheets. In some embodiments, the dispersed particles have a longest dimension of 0.5 to 5 μm, preferably 1 to 4 μm, and preferably 2 to 3 μm. In some embodiments, the agglomerated layers of wave-like sheets may have 2 to 500 layers, preferably 10 to 400 layers, more preferably 50 to 300 layers, and yet more preferably 100 to 200 layers.

In some embodiments, the MOF includes carbon in an amount of 50 to 70, preferably 55 to 65, and preferably 57 to 63 atomic percent (at. %) based on the total atom count of the MOF. In some embodiments, the MOF includes oxygen in an amount of 25 to 45, preferably 30 to 40, and preferably 32 to 38 atomic percent (at. %) based on the total atom count of the MOF. In some embodiments, the MOF includes the metal in an amount of 1 to 5, preferably 2 to 4, and preferably 2.5 to 3.5 atomic percent (at. %) based on the total atom count of the MOF.

In some embodiments, when the metal is cobalt, the MOF has a Brunauer-Emmett-Teller (BET) specific surface area of 250 to 350 m²/g, preferably 275 to 325 m²/g, preferably 290 to 310 m²/g, more preferably 295 to 305 m²/g, and yet more preferably about 300 m²/g. In some embodiments, when the metal is nickel, the MOF has a BET-specific surface area of 800 to 900 m²/g, preferably 825 to 875 m²/g, preferably 845 to 865 m²/g, more preferably 855 to 860 m²/g, and yet more preferably about 858 m²/g. In some embodiments, when the metal is cobalt and nickel, the MOF has a BET-specific surface area of 550 to 650 m²/g, preferably 575 to 625 m²/g, preferably 590 to 620 m²/g, more preferably 605 to 615 m²/g, and yet more preferably about 611 m²/g. In some embodiments, when the metal is cobalt, the MOF has a micropore volume of 0.70 to 0.75 cm²/g, preferably 0.72 to 0.74 cm²/g, preferably 0.725 to 0.735 cm²/g, more preferably 0.730 to 0.732 cm²/g, and yet more preferably about 0.731 cm²/g. In some embodiments, when the metal is nickel, the MOF has a micropore volume of 0.25 to 0.30 cm²/g, preferably 0.26 to 0.29 cm²/g, preferably 0.265 to 0.275 cm²/g, more preferably 0.271 to 0.274 cm²/g, and yet more preferably about 0.2737 cm²/g. In some embodiments, when the metal is cobalt and nickel, the MOF has a micropore volume of 0.2000 to 0.2500 cm²/g, preferably 0.2100 to 0.2400 cm²/g, preferably 0.2200 to 0.2370 cm²/g, more preferably 0.2300 to 0.2350 cm²/g, and yet more preferably about 0.2334 cm²/g. The PCM has a thermal stability of 200 to 400° C., preferably 225 to 375° C., preferably 250 to 350° C., more preferably 275 to 325° C., and yet more preferably 290 to 310° C., based on thermogravimetric analysis (TGA).

In some embodiments, when the metal is nickel, the PCM has a melting latent heat value of 150 to 160 J/g, preferably 151 to 159 J/g, more preferably 152 to 158 J/g, and yet more preferably about 156 J/g. In some embodiments, when the metal is nickel, the PCM has a freezing latent heat value of 125 to 140 J/g, preferably 127 to 139 J/g, more preferably 128 to 138 J/g, and yet more preferably 130 to 137. In some embodiments, when the metal is cobalt, the PCM has a melting latent heat value of 135 to 140 J/g, preferably 136 to 139 J/g, and preferably 138 to 139 J/g.

In some embodiments, when the metal is nickel, the MOF has a solar-to-thermal energy storage efficiency of 40 to 90 percent, preferably 50 to 80 percent, and more preferably 70 to 75 percent. In some embodiments, when the metal is nickel, the PCM has a thermal stability of at least 200 differential scanning calorimetry melting and freezing cycles, based on a solar-to-thermal conversion value. The solar-to-thermal conversion value is 0.5 to 1.0 percent less than an initial solar-to-thermal conversion value.

In some embodiments, the PCM has a super cooling value of 18 to 23° C., preferably 19 to 22° C. In some embodiments, the PCM has a thermal conductivity of 0.2200 to 0.3500 W m⁻¹ K⁻¹, preferably 0.2300 to 0.3400 W m⁻¹ K⁻¹, preferably 0.2400 to 0.3300 W m⁻¹ K⁻¹, more preferably 0.2500 to 0.3250 W m⁻¹ K⁻¹, and yet more preferably 0.2600 to 0.3200 W m⁻¹ K⁻¹.

### EXAMPLES

The following examples demonstrate a phase change material (PCM), including polyethylene glycol (PEG) in a metal-benzene tricarboxylic acid (BTC) matrix for thermal energy storage. The examples are provided solely for illustration and are not to be construed as limitations of the present disclosure, as many variations thereof are possible without departing from the spirit and scope of the present disclosure.

### Example 1: Materials

The experimental materials were supplied by Sigma-Aldrich Co., located in St. Louis, MO, USA. These materials included polyethylene glycol (molecular weight of 6000), trimesic acid (1,3,5-benzenetricarboxylic acid (BTC)) (98% purity), nickel nitrate hexahydrate (99.99% purity) (Ni(NO₃)₂·6H₂O), cobalt nitrate hexahydrate (99.99% purity) (Co(NO₃)₂·6H₂O), methanol (99.9% purity), N,N-dimethylformamide (99.8% purity), acetic acid (99.0% purity) (CH₃COOH), dichloromethane (99.8% extra dry grade), and solvent grade ethanol.

### Example 2: Preparation of Cobalt (Co)-Molecular Organic Framework (MOF) (Co-(1,3,5-benzenetricarboxylic acid (BTC))) (Co-BTC or Co-BTC-MOF)

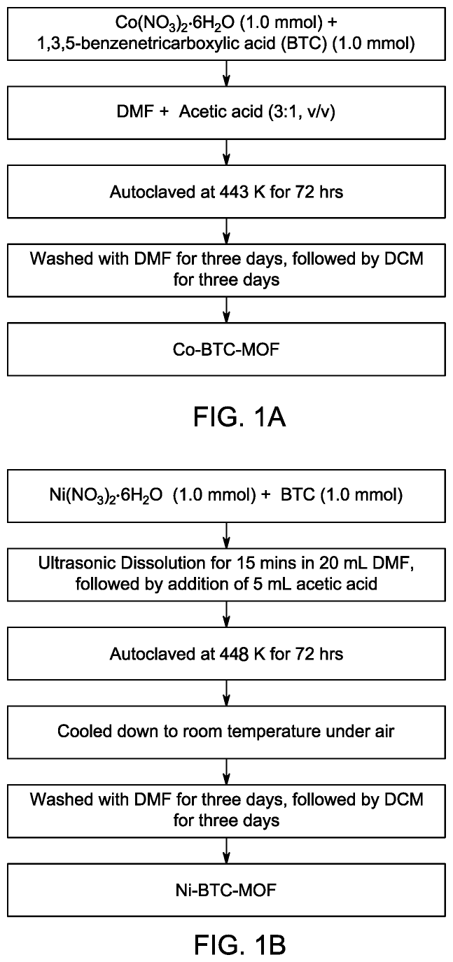

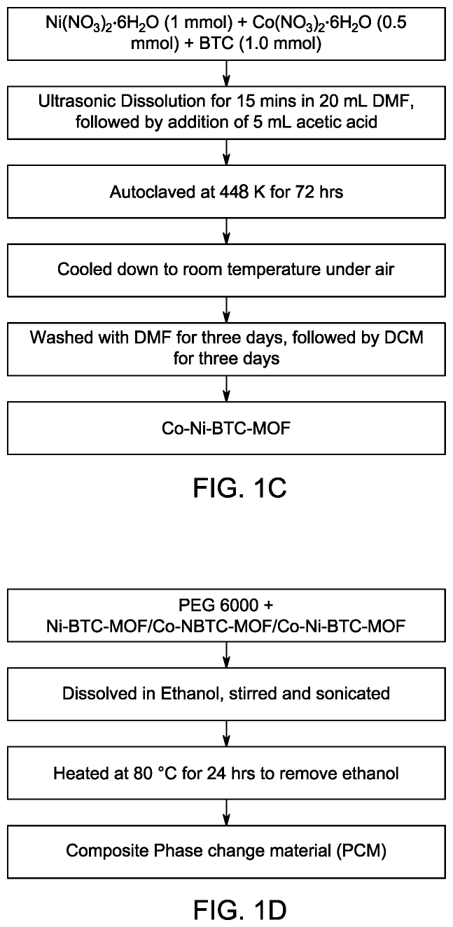

A mixed solvent system comprising dimethylformamide (DMF) and acetic acid was used to synthesize the Co-BTC MOF through a solvothermal transformation of Co(NO₃)₂·6H₂O and 1,3,5-benzenetricarboxylic acid (BTC). The Co(NO₃)₂·6H₂O (1.0 mmol, 0.290 g) and 1,3,5-benzenetricarboxylic acid (1.0 mmol, 0.210 g) were dissolved in a mixture of solvents (DMF/acetic acid) (v/v=3:1) and heated at 443 K for 72 hours in a 40 mL autoclave. The resultant material was washed with DMF for three days, followed by immersion in dichloromethane for 3 days. The MOF formed was immersed in DMF for three days, and the DMF was replaced with fresh DMF every day. Then, after three days, DMF was replaced with dichloromethane, and the same procedure was repeated. The activation solvent was emptied and re-filled three times during this process, resulting in a 51% yield (based on the cobalt salt) of the Co-BTC (FIG. 1A).

### Example 3: Preparation of Nickel (Ni)-Molecular Organic Framework (MOF) (Ni-BTC or Ni-BTC-MOF)

To synthesize Ni-BTC, Ni(NO₃)₂·6H₂O (291 mg, 1.0 mmol) and BTC (210 mg, 1.0 mmol) were dissolved in 20 mL of DMF with ultrasonic dissolution for 15 minutes. Afterward, 5 mL of acetic acid was added, and the mixture was moved to a 40 mL autoclave, which was heated to 448 K and left for 72 hours. The system was then allowed to cool down to room temperature under air. At this stage, a green solid was obtained, which was washed 3 times with 10 mL of DMF for three days followed by 3 times with 10 mL of CH₂Cl₂ for three days to achieve Ni-BTC. The Ni-BTC yield was 35% based on the nickel salt (FIG. 1B).

### Example 4: Preparation of Co—Ni-Molecular Organic Framework (MOF) (Co—Ni-BTC or Co—Ni-BTC-MOF)

Ni(NO₃)₂·6H₂O (291 mg, 1.0 mmol), Co(NO₃)₂·6H₂O (146 mg, 0.5 mmol), and BTC (210 mg. 1.0 mmol) were dissolved in DMF (20 mL) by ultrasonic dissolution for 15 minutes. Then, 5 mL of acetic acid was added. The resulting mix was moved to a 40 mL autoclave and heated at 448 K for 72 hours. The system was then allowed to cool down to room temperature under air. The microcrystalline powdered material obtained was washed 3 times with 10 mL of DMF for three days and 3 times with 10 mL of CH₂Cl₂ for three days, yielding Co—Ni-BTC with a 47% yield based on the metal salts (FIG. 1C).

The composite PCM of 0.1 g, 0.5 g, or 0.7 g PEG-6000 were mixed with 0.2 g of Ni-BTC-MOF, Co-BTC-MOF, or Ni-Co-BTC-MOF. Three types of samples were dissolved in 50 mL ethanol. The solution was stirred for 30 minutes and then sonicated for another 30 minutes. The solution was heated to 80° C. for 24 hours to remove the ethanol by evaporation, while being continuously stirred (FIG. 1D).

### Example 5: X-Ray Diffraction (XRD) Studies of Metal-MOF and PCM

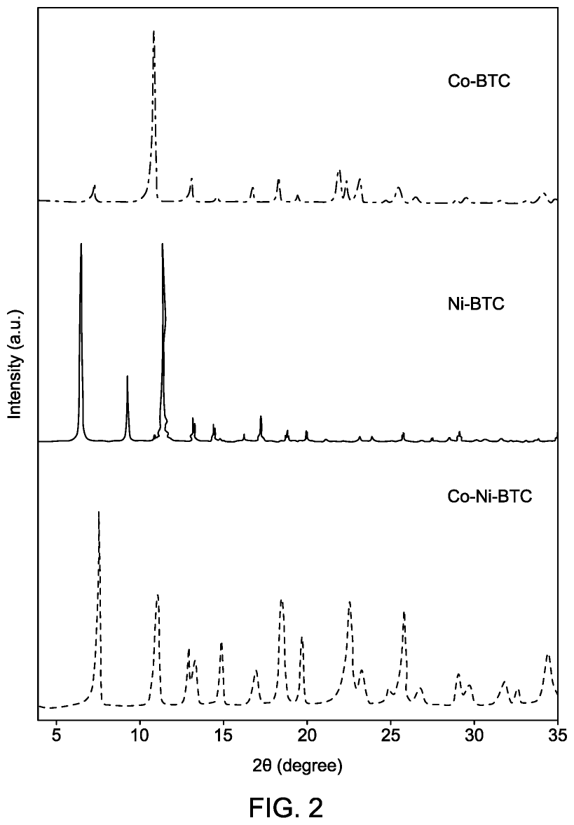

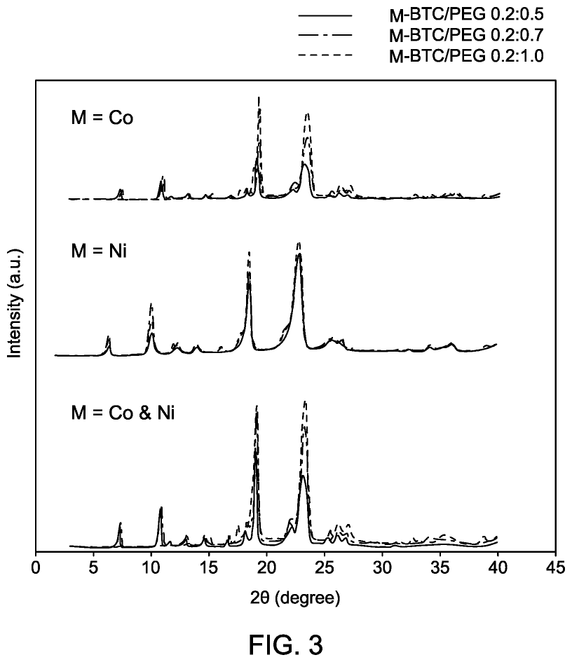

The physical properties, such as phase composition, crystal structure, and orientation of powder, solid, and liquid samples, were analyzed by XRD. The materials were analyzed using a Bruker D8 advanced diffractometer (Berlin, Germany). The diffractometer was operated at a voltage of 40 kV and a current of 40 mA, with CuKα emission and monochromator graphite λ=1.5405 Å. The XRD patterns were taken from 2θ=3−70 at a scan speed of 2°/min. The characteristic peaks of Co-BTC appear at 12.1° (011) and 14.7° (−102) (FIG. 2). The XRD pattern of Ni-BTC samples indicates that as-synthesized Ni-BTC is crystalline and pure. Intense peaks in the XRD pattern of Co—Ni-BTC (FIG. 2), suggests that the material is crystalline. The topology of Co—Ni-BTC is like that of Co-BTC, which is evident by the peaks at 7.5° and 11.06°. Additionally, XRD data reveal that the peak intensities of the as-synthesized samples only partially match the known patterns, showing that the crystals have favored growth orientations. FIG. 3 shows the XRD patterns of metal (M)-BTC/PEG, wherein the metal (M) is cobalt, nickel, and cobalt and nickel and the metal-BTC and PEG are in the ratio of 0:2:0.5, 0.2:0.7, and 0.2:1.0. The most prominent peaks in the 2θ axis located between 18° and 25° in samples containing PEG indicate that PEG and Ni-BTC, Co-BTC, and Co—Ni-BTC are subjected to only physical mixing without any chemical reaction. In addition, phase pure PEG displays more intense peaks than PEG in the PCM composites. The height of peaks due to PEG in Ni-BTC/PEG is lower and the peaks are slightly broader, indicating that PEG occupies the pores in the PCM, reducing the size of the crystallites of PEG. Moreover, the peaks of the Co-BTC/PEG and Ni-BTC/PEG composite are the smallest, indicating the incorporation of an amount of PEG into composite pores. Ni-BTC/PEG, among the other PCM composites, showed the largest peak height drop compared to PEG.

### Example 6: Fourier-Transform Infrared Spectroscopy (FTIR) of Metal-MOF and PCM

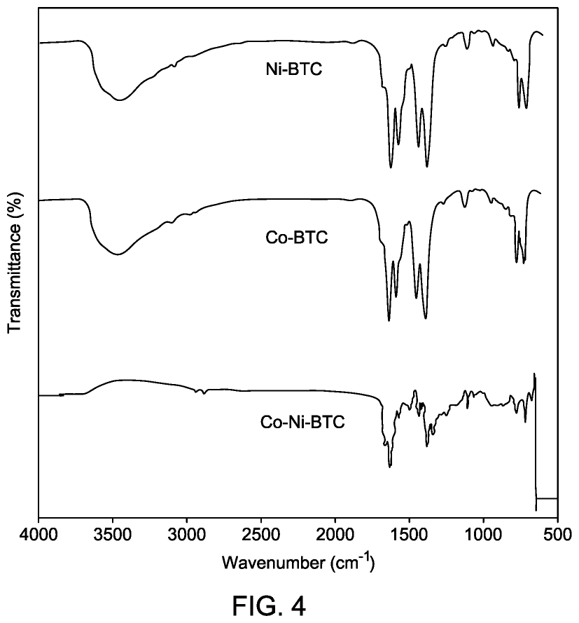

Fourier-transform infrared (FTIR) spectra were captured using the KBr pellet method with Bruker FTIR spectroscopy. FTIR spectra support the formation of Co-BTC, Ni-BTC, and Co—Ni-BTC (FIG. 4). In the Ni-BTC FTIR spectrum, the stretching vibration at 727 cm⁻¹ is due to the Ni—O coordination. The stretching vibration of C—O is indicated by the peak at 1373 cm⁻¹. The absorption peak at 1650 cm⁻¹ is due to the stretching of vC-O and reveals a bathochromic effect compared to the absorption band of 1720 cm⁻¹ in H₃BTC, demonstrating a Ni²⁺—O coordination. The existence of a carboxylic acid group is revealed by the O—H vibration at 1443 cm⁻¹ (FIG. 4). The spectra of Ni-BTC and Co-BTC also show the existence of loosely linked water molecules, resulting in a very broad peak around 3000-3600 cm⁻¹ centered around 3447 cm⁻¹. In the FTIR spectra (FIG. 4), the vibration bands at 713 and 765 cm⁻¹ are attributed to out-of-plane aromatic C-H bending modes of the linker BTC. Strong bands at 1371 cm⁻¹, 1439 cm⁻¹, and 1577 cm⁻¹ are ascribed to the symmetric and asymmetric C—O stretching modes of the COO-groups, while the peak at 1103 cm⁻¹ is attributable to the aromatic C—H in-plane bending. The FTIR spectrum of Co—Ni-BTC resemble those of Co-BTC and Ni-BTC. The bands observed at 721 and 788 cm⁻¹ are attributed to out-of-plane aromatic C—H bending modes of BTC. The strong bands at 1377 cm⁻¹, 1436 cm⁻¹, 1568 cm⁻¹, and 1628 cm⁻¹ are attributed to the symmetric and asymmetric C—O stretching modes of the COO⁻ groups. The peak at 1106 cm⁻¹ is also attributed to the aromatic C—H in-plane bending. The coordinated H₂O molecules are represented by the O—H stretching vibrations of a broad band at around 3000 cm⁻¹.

The bands at 2890-2780 cm⁻¹ in the Co-BTC FTIR spectrum indicate the existence of H₂N⁺ in the assembly. The absence of the adsorption bands due to —COOH in the region of 1800-1680 cm⁻¹ indicates deprotonation of formic and BTC ligands. The characteristic bands of the carboxylate groups in the regions of 1645-1550 cm⁻¹ (asymmetric vibration) and 1470-1390 cm⁻¹ indicate coordination of BTC and formate ligands with the metal ions. The stretching vibrations of the C—C group, as well as the in-plane and out-of-plane distortion vibrations of the C—H groups of the aromatic ring are also present in the regions of 1100 cm⁻¹ and 866-715 cm⁻¹, respectively. Carboxylate groups are represented by absorption bands in the range of 1645-1550 cm⁻¹ (asymmetric vibration) and 1440-1390 cm⁻¹ (symmetric vibration), suggesting coordination of —COOH groups and cobalt ions. The bands due to C—C and C—H groups of benzene rings of Co-BTC appear at 1100 cm⁻¹ and 866-715 cm⁻¹, respectively.

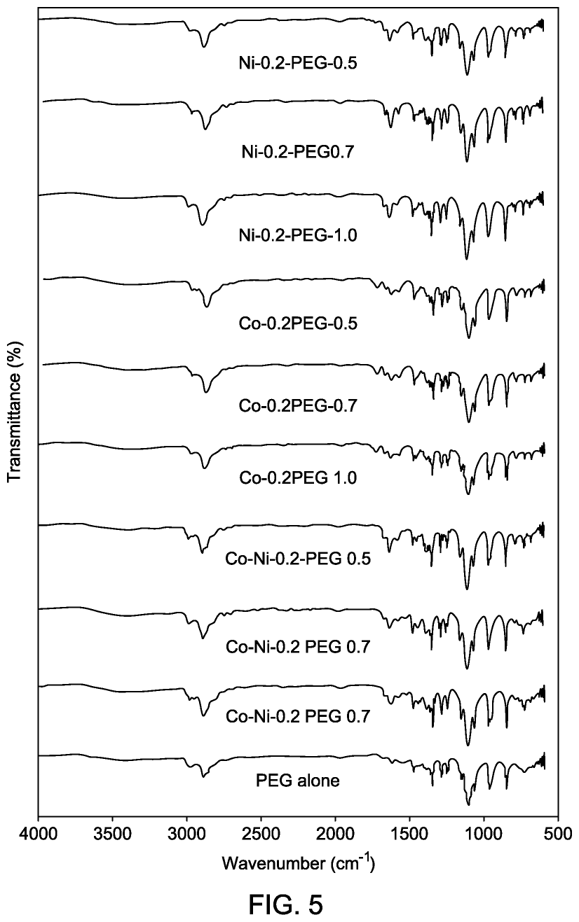

FIG. 5 displays FTIR bands of PEG alone and metal-MOF (BTC)/PEG, wherein the metal is nickel, cobalt, and nickel and cobalt and the metal-MOF and PEG are in the ratio of 0:2:0.5, 0.2:0.7, and 0.2:1. The FTIR (FIG. 5) spectra of the composites show characteristic bands due to Co-BTC, Ni-BTC, and PEG peaks, indicating physical mixing, without any chemical reaction, leading to well-mixed Ni-BTC/PEG, Co-BTC/PEG, and Co—Ni-BTC/PEG composites. These observations indicate that the individual species of the composites and the support remain almost unchanged.

### Example 7: Field Emission Scanning Electron Microscope (FESEM) of metal-MOF and PCM

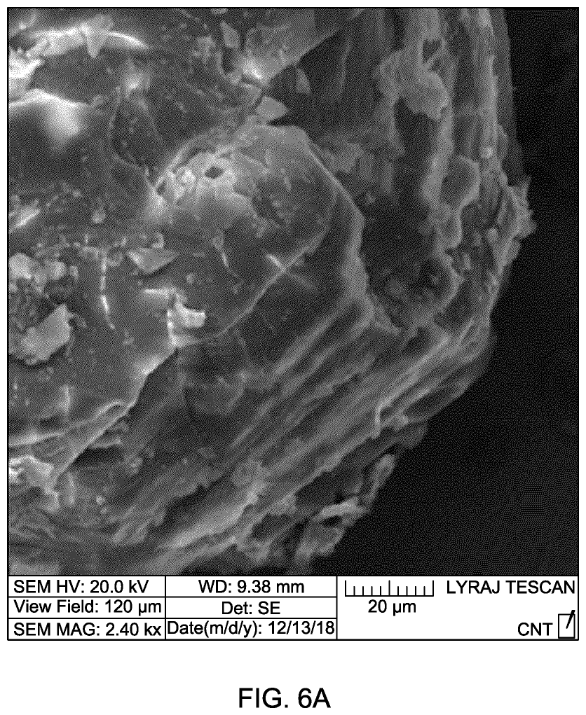

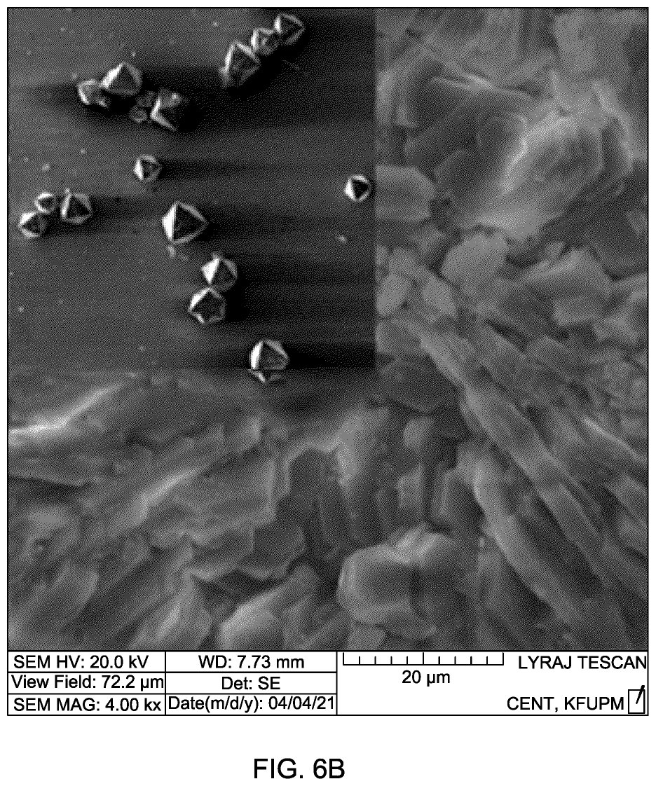

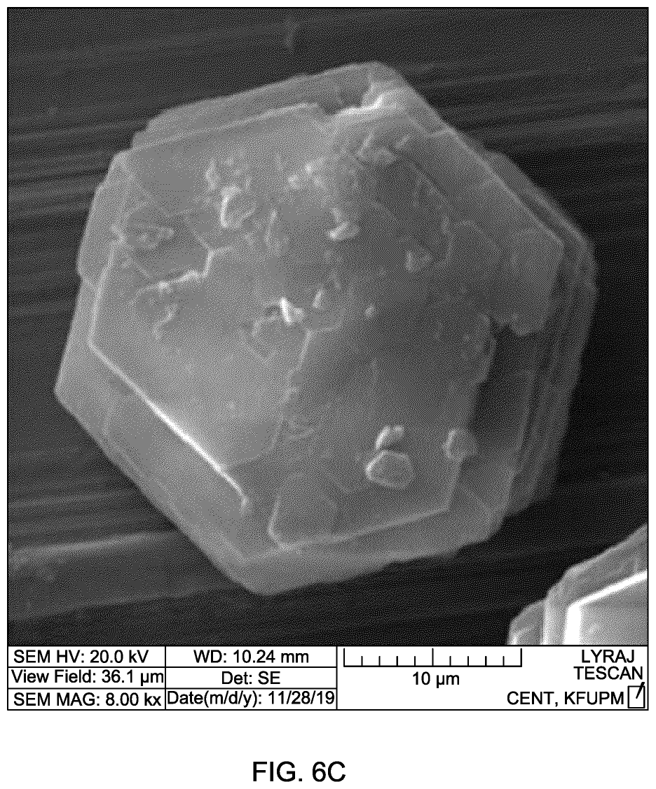

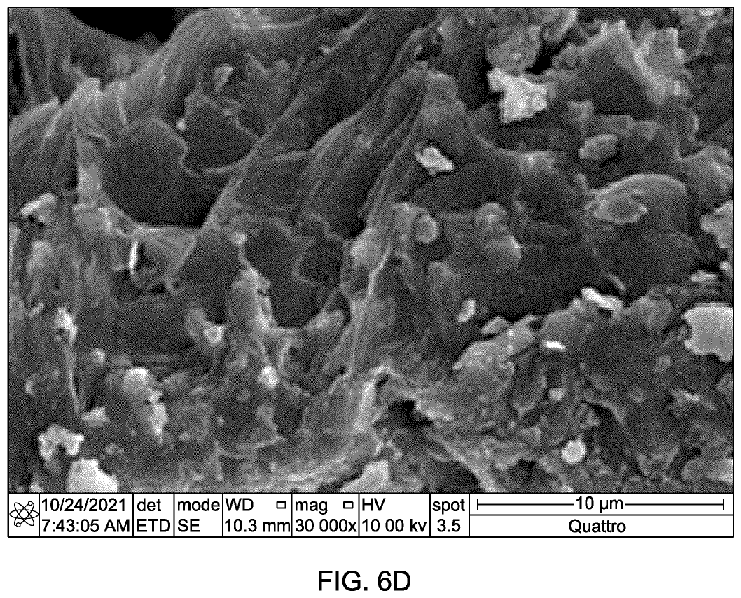

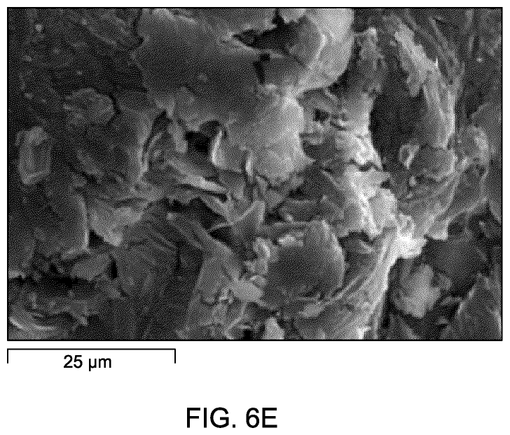

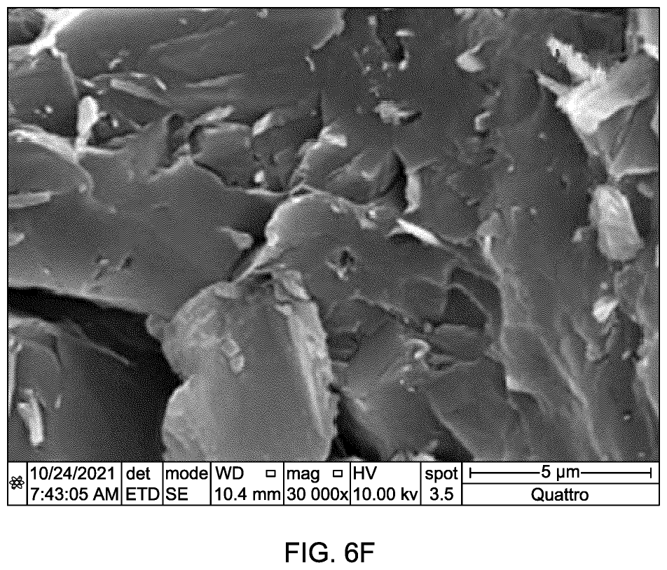

The particle size and morphology of the synthesized material were analyzed with FESEM at an acceleration voltage of 10 kV using the TESCAN LYRA3 instrument in Brno, Czech Republic. SEM image of Co-BTC shows layer type morphology of a new structure containing hexagonal prisms (FIG. 6A). The SEM image of microcrystalline Ni-BTC suggests the formation of round flower-shaped assemblies (FIG. 6B). However, images of Ni-BTC at a higher magnification show a pyramid-type (inset of FIG. 6B) morphology. The SEM image of Co—Ni-BTC has particles with a hexagonal benzene-type morphology (FIG. 6C) and a layer-by-layer crystal structure. When PEG is mixed with the MOFs (FIGS. 6D-6F), three different types of morphology are formed. Clay-like sheets with a wave-like morphology were formed in the case of Co-BTC/PEG. Ni-BTC/PEG powders have a morphology of agglomerated sheets (clay type). The Co—Ni-BTC/PEG powder also has a clay-like morphology with smooth surfaces.

### Example 7: Energy-Dispersive Spectra (EDS) of Metal-MOF and PCM

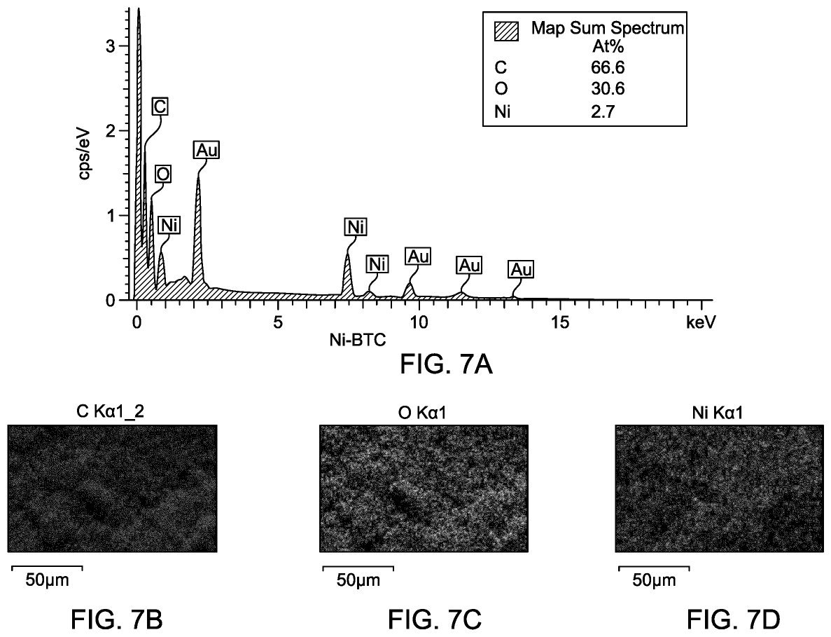

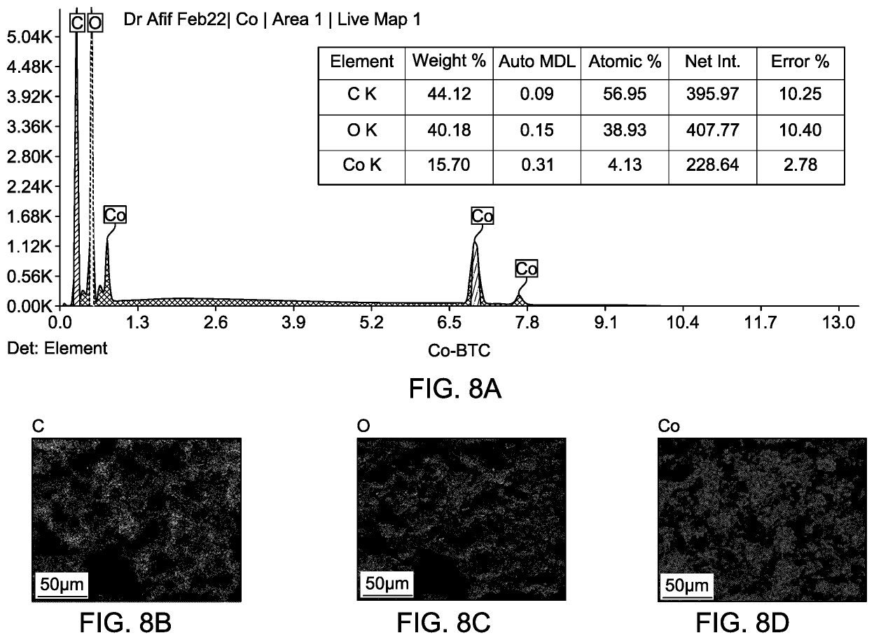

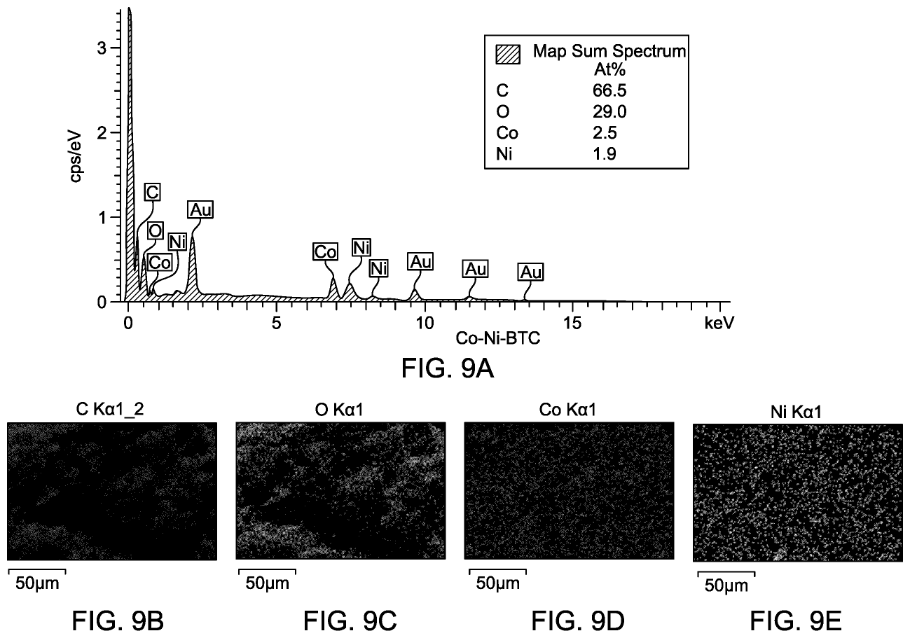

EDS was acquired with an Oxford Instruments X-mass detector fitted to the same TESCAN LYRA3 FESEM machine. The EDS spectra of Ni-BTC (FIGS. 7A-7D), Co-BTC (FIGS. 8A-8D), and Co—Ni-BTC (FIGS. 9A-9E) confirm the existence of carbon and oxygen in all samples. The elemental mapping images indicate that the constituent elements are uniformly distributed. The XRD pattern in FIG. 3 showed Ni-BTC/PEG showed the largest peak height drop compared to the other PCM composites. This shows that a greater amount of PEG can penetrate Ni-BTC (with an R-value of 85.0%) than Co-BTC or Co—Ni-BTC without affecting the MOF framework's crystalline structure. No vapor or gas formed during the melting cycle. Additionally, no voids were created as the material solidified.

### Example 8: Nitrogen Adsorption Isotherms Analysis of Metal-MOF and PCM

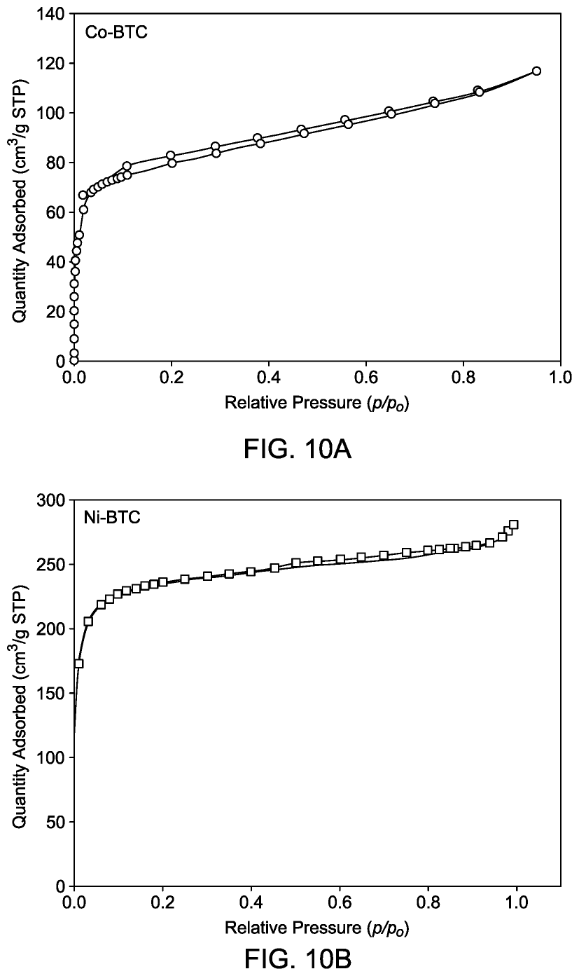

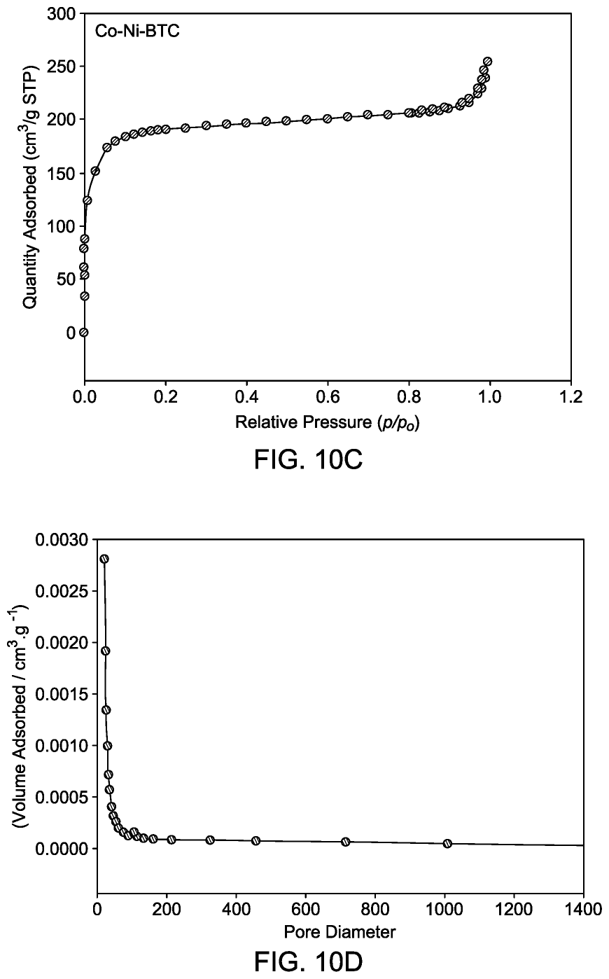

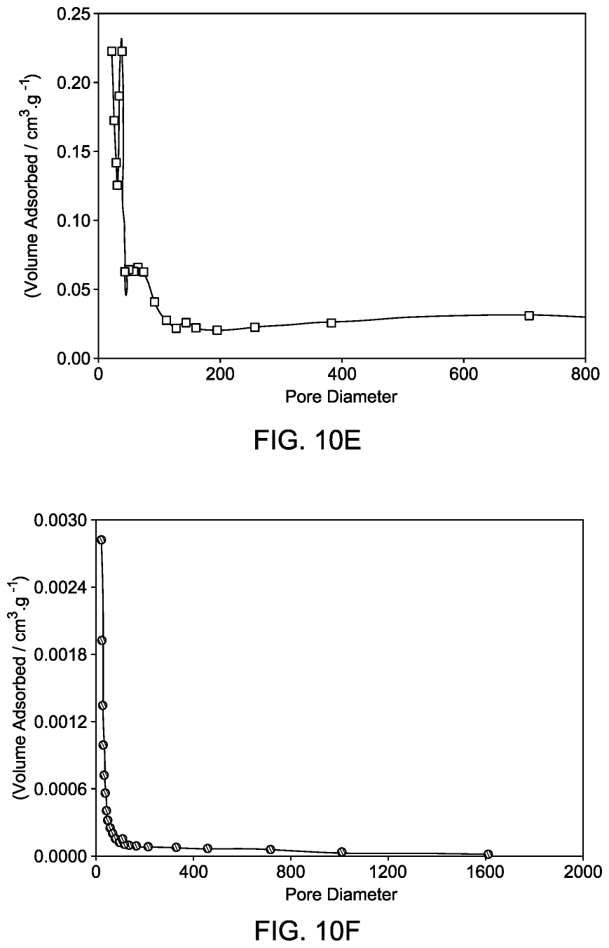

Ni-BTC was examined further with nitrogen adsorption analysis to calculate the BET surface area and pore size distribution. A NOVA-1200 instrument (JEOL USA Inc.) was used to measure the BET surface area, pore size, and specific pore volume of the solid samples. The BET specific surface area was calculated using a Tristar II 3020 device. Before recording the nitrogen adsorption isotherms, the powders were treated under a dry nitrogen environment for three hours by raising the temperature to 600° C. at a rate of 5° C./min. The isotherms of N₂ adsorption were recorded at a liquid N₂ temperature of −196° C. The recorded isotherm data was further processed to calculate multipoint Brunauer, Emmett, and Teller (BET) surface area, pore size/volume, and pore size distribution by the Barrett-Joyner-Halenda (BJH) method. The pore size distribution was analyzed using the BJH isotherm. Nitrogen adsorption/desorption isotherms of the MOF samples (M-BTC, where M=Co, Ni, and Co—Ni) are shown in FIG. 10A-FIG. 10C, while the corresponding BJH pore size distributions are presented in FIG. 10D-FIG. 10F. Before the adsorption/desorption process, the samples were subjected to pre-treatment at 80° C. for 10 hours. The porous characteristics of the synthesized samples are confirmed by both the isotherms and pore size distribution plots. The Ni-BTC synthesized sample follows a type-IV isotherm, which indicates a mesoporous nature of the pores. Furthermore, the presence of slit-shaped pores is indicated by the type-H3 hysteresis loop between the relative pressure of 0.15 to 1.0. Type-H3 isotherms display no limiting adsorption at high P/P₀, which is typically observed in non-rigid assemblies of particles with a plate-like structure [S. Bauer, T. Bein, N. Stock, High-throughput investigation and characterization of cobalt carboxy phosphonates, Inorganic Chemistry. 44 (2005) 5882-5889, which is incorporated herein by reference in its entirety], which was supported by the SEM images (FIGS. 6-9). The N₂ adsorption and desorption isotherms of Co-BTC overlapped in the low relative pressure range (P/P₀<0.5) but are slightly separated at higher relative pressure ranges (P/P₀>0.85), indicating weak adsorption (FIG. 10A). The isotherms of Co-BTC display both types I and IV characteristics, indicating the presence of micropores and mesopores in the material [D.G. Atinafu, S.J. Chang, K.H. Kim, W. Dong, S. Kim, A novel enhancement of shape/thermal stability and energy-storage capacity of phase change materials through the formation of composites with 3D porous (3,6)-connected metal-organic framework, Chemical Engineering Journal. 389 (2020) 12443, which is incorporated herein by reference in its entirety]. The BJH pore size distribution also confirms the presence of mesopores in Co—Ni-BTC (FIG. 10C). The adsorption/desorption isotherms of the bimetallic Co—Ni-BTC sample were similar to that of Ni-BTC sample. The calculated BET specific surface area of the Co-BTC, Ni-BTC, and Co—Ni-BTC samples are 300 m²/g, 858 m²/g, and 611 m²/g, respectively. The micropore pore volumes for the Co-BTC, Ni-BTC, and Co—Ni-BTC samples are 0.7316 cm²/g, 0.2737 cm³/g, and 0.233401 cm³/g, respectively.

### Example 9: X-Ray Photoelectron Spectroscopy (XPS) of Metal-MOF and PCM

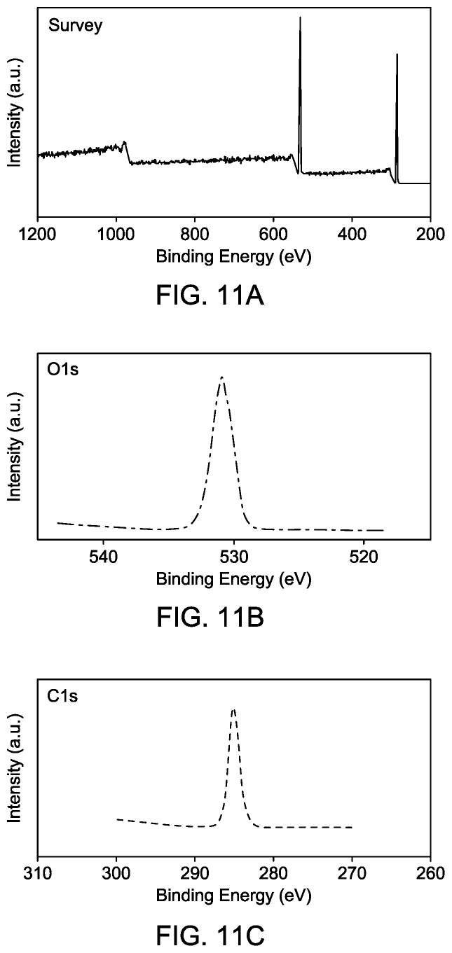

The compositions of the synthesized samples were measured by X-ray photoelectron spectroscopy (XPS) performed with an ESCALAB-250 XPS (Thermo-VG Scientific, Waltham, Peabody, MA, USA) with Al-K radiation (1486.6 eV) at ambient temperature with a pressure of 5×10⁻¹⁰ mbar maintained in the specimen chamber. The XPS spectrum of Ni-BTC (FIG. 11A) shows peaks at 855 eV and 872 eV attributed to Ni 2p_{3/2} and 2p_{1/2}, indicating that nickel mostly appears as Ni²⁺. There is an additional peak at 397 eV corresponding to Ni 1s. The representative peaks of C and O were observed at 284 eV (C1s) (FIG. 11C) and 532 eV (O1s) (FIG. 11B), respectively. XPS also elucidates the surface properties and chemical nature of materials. There are four binding peaks appearing at around 284.6 eV and 404.08 eV in each full range spectra that are conferred to the C1s and O1s levels, respectively (FIG. 11). The binding energy (B.E.) in the Ni-BTC XPS spectrum positioned at 400 eV and 402 eV are given to C—N—C and N—H, correspondingly [A. Helal, M. Naeem, M.E. Arafat, M.M. Rahman, Europium doped Ni (BTC) metal-organic framework for detection of heteroaromatic compounds in mixed aqueous media, Materials Research Bulletin. 146 (2022) 111604, which is incorporated herein by reference in its entirety]. The proportioned elements related to the satellite line are used to fit the CO 2p spectra. Peaks at 282 eV, 289.5 eV, and 526 eV are thought to be due to the COH and/or OH functions. The occurrence of an OH group has been proposed to have an effect on decreasing the super cooling outcome of the materials [C. Li, H. Yu, Y. Song, M. Zhao, Synthesis and characterization of PEG/ZSM-5 composite phase change materials for latent heat storage, Renewable Energy. 121 (2018) 45-52, which is incorporated herein by reference in its entirety]. The C1s spectrum (FIG. 10C) was tailored with five consistent peaks at 284.8 eV, 286.2 eV, 287.1 eV, 288.4 eV, and 289.5 eV, corresponding to C—C, C—N, C—O, C═O, and O—C═O groups, respectively.

### Example 10: Thermogravimetric Analysis (TGA) of PCM

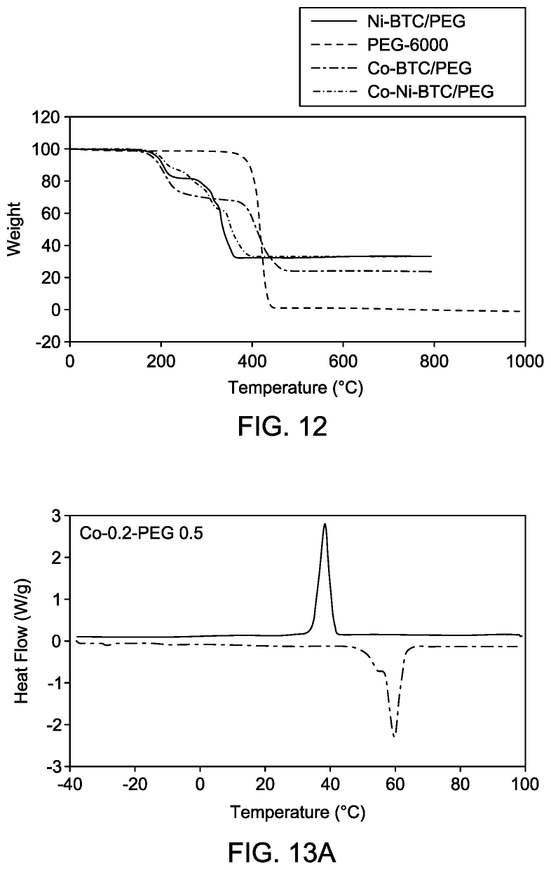

TGA of the solid materials was conducted by using a Shimadzu TA-50 thermal analyzer, received from Tokyo, Japan. The TGA data were acquired using ˜10 mg of solid samples. The TGA data of all samples, including the TGA profile of PEG, were recorded at a temperature ramping rate of 10° C./min under atmospheric air (FIG. 12). TGA data of Co-BTC and Ni-BTC showed two major weight losses from room temperature to 600° C. The initial weight loss of 26.50% up to 400° C. is owing to the loss of both water and solvent molecules. The second weight loss of 40.67% is detected above 400° C. and is responsible for the dissociation of carbon-based ligands of Ni-BTC. Generally, Ni-BTC is stable up to 400° C. and completely decomposes into NiO after 400° C., leaving a residue of 39.3%. In the first of the two steps, the physiosorbed and coordinated moisture molecules are lost in the range of 60-200° C. (6.03 wt. %, 2.81 wt. %). The second of the two steps, between 200 and 450° C., is assigned to the disintegration of the MOF (18.76 wt. %, 36.59 wt. %), which agrees with the estimated value of 55.91%. The remaining weight of Ni-BTC is around 35.81 wt. %, which agrees well with that determined using the decomposition product, i.e., NiO (FIG. 5). The shape of the TGA profiles of both the Ni-BTC and Co-BTC samples are similar (FIG. 12). The weight loss of the samples up to 250° C. are almost identical, and after that, the weight loss and the rates for Ni-BTC sample was higher than that of Co-BTC sample.

The composites consist of approximately 28.6% of the Co-BTC, Ni-BTC, or Co—Ni-BTC matrix and 71.4% of PEG, showing a completely different TGA profile. The synthesized PEG phase change materials show very good thermal stability below 400° C., as shown in FIG. 12. The weight loss curve of PEG alone contains only a single step. The thermal stability of the PCM is a parameter to determine heat storage applications. The porous Ni-BTC support improves the thermal stability of PEG by creating a self-protective barrier. The mixtures have a high thermal stability, making them appropriate for use in energy storing systems. The TGA data indicates that the MOF matrix prevents the decomposition of encapsulated PEG.

### Example 11: Differential Scanning Calorimetry (DSC) of PCM

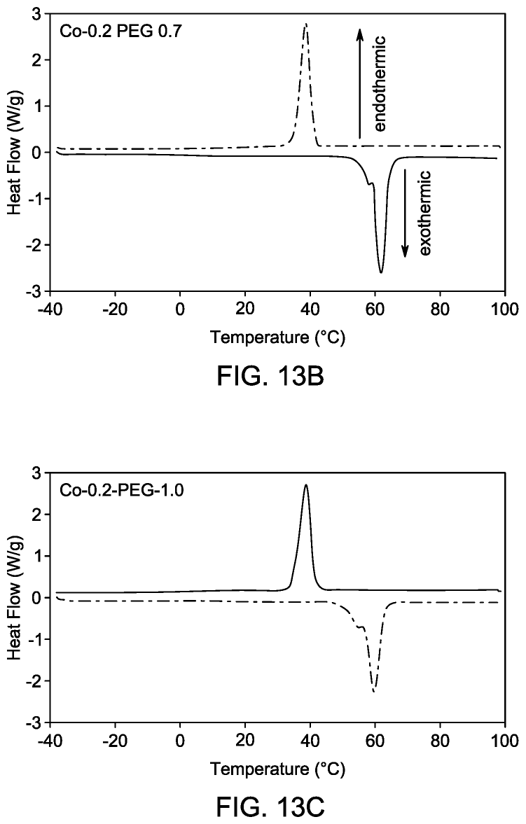

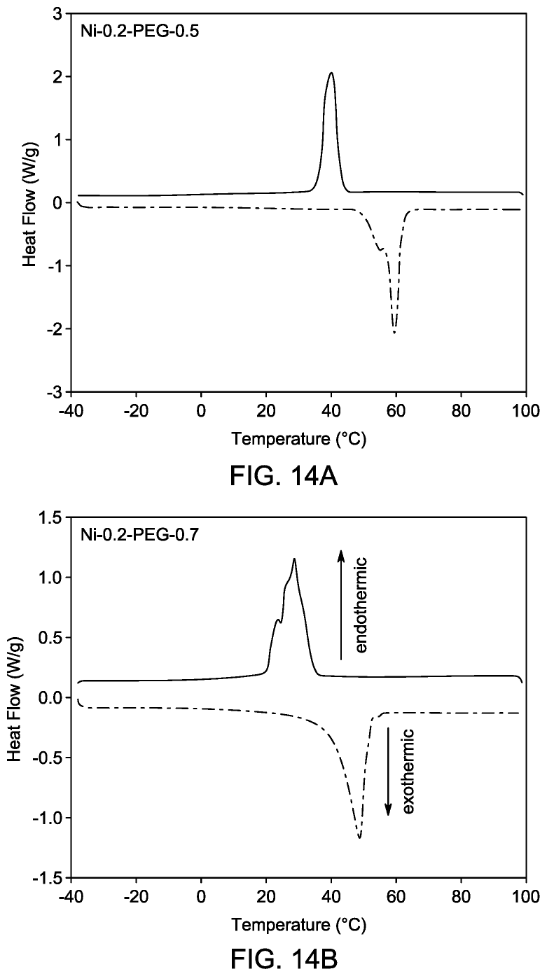

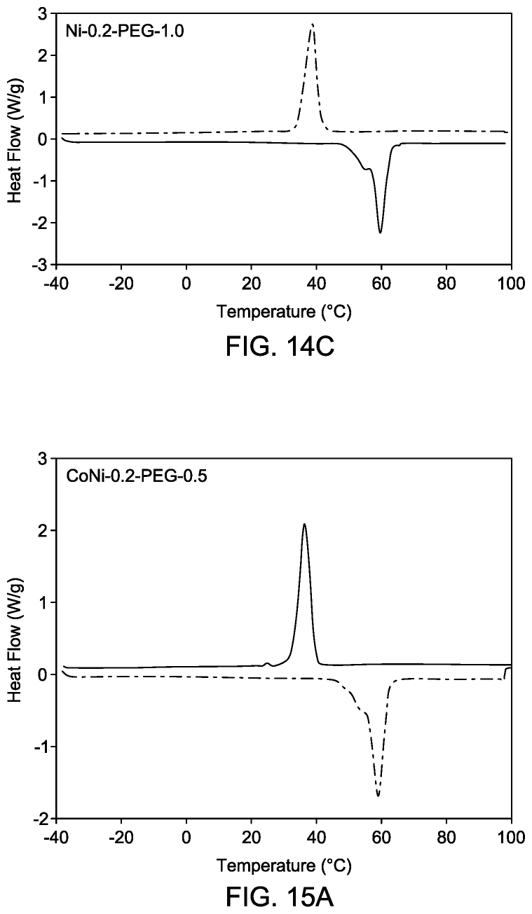

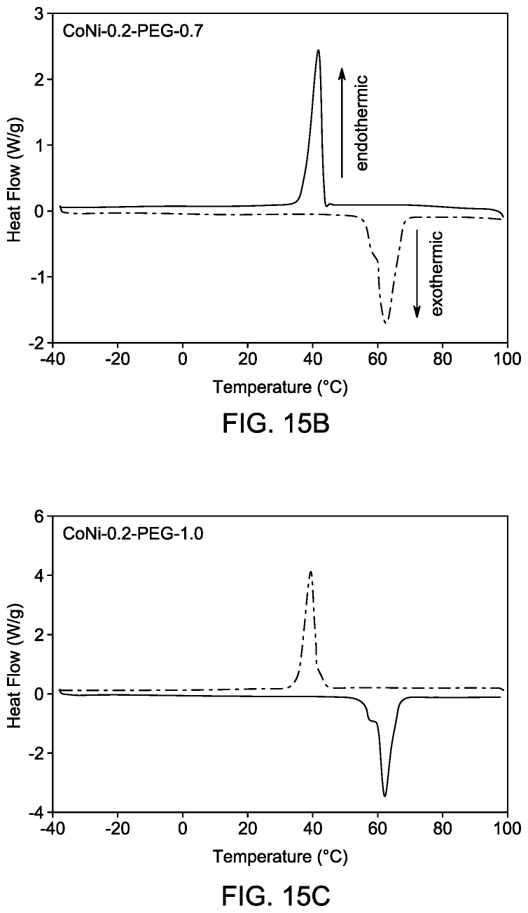

DSC-Q2000 was employed to identify the melting point, freezing point, and latent heat of the samples. In DSC analysis, the data were collected by heating (5° C./min) 8.5 mg of sample in sealed aluminum pans under an Ar gas flow rate of 20 mL/min. The melting-freezing DSC curves of Co-BTC/PEG, Ni-BTC/PEG, and Co—Ni-BTC/PEG with different PEG content are shown in FIGS. 13A-13C, FIGS. 14A-14C, and FIGS. 15A-15C, respectively. In Co-BTC/PEG, ratios of Co-BTC to PEG are 0:2:0.5, 0.2:0.7, and 0.2:1, and are shown in FIG. 13A, FIG. 13B, and FIG. 13C, respectively. Similarly, in Ni-BTC/PEG, ratios of Ni-BTC to PEG are 0:2:0.5, 0.2:0.7, and 0.2:1, and are shown in FIG. 14A, FIG. 14B, and FIG. 14C, respectively. In Co—Ni-BTC/PEG, Co—Ni-BTC and PEG are in ratios of 0:2:0.5, 0.2:0.7, and 0.2:1, and are shown in FIG. 15A, FIG. 15B, and FIG. 15C, respectively. Based on the area under the DSC curves for the freezing and melting cycles, the latent heat values were determined. Pure PEG has corresponding melting and freezing enthalpies of 189.6 J/g and 170.1 J/g, respectively. The highest melting and freezing latent heat values of 156.0 J/g and 137.0 J/g, respectively, were observed for 0.2:0.7 Ni-BTC/PEG PCM. The parameters presented in Table 1 were calculated according to equations 1-4 [T. Qian, J. Li, X. Min, Y. Deng, W. Guan, H. Ma, Polyethylene glycol/mesoporous calcium silicate shape-stabilized composite phase change material: Preparation, characterization, and adjustable thermal property, Energy. 82 (2015) 333-340; and C. Li, B. Zhang, B. Xie, X. Zhao, J. Chen, Tailored phase change behavior of Na₂SO₄·10H₂O/expanded graphite composite for thermal energy storage, Energy Conversion and Management. 208 (2020) 112586, both of which are incorporated herein by references in their entireties]. Table 1 includes PCMs that are similar to the ones analyzed in this study, which are included for the sake of comparison.

$$R = \frac{Δ {H}_{m , com}}{Δ {H}_{m , PEG}} \times 100 \qquad ( 1 )$$

$$E = \frac{Δ {H}_{m , com} + Δ {H}_{f , com}}{Δ {H}_{m , PEG} + Δ {H}_{f , PEG}} \times 100 \qquad ( 2 )$$

$$φ = \frac{\frac{Δ {H}_{m , com} + Δ {H}_{f , com}}{R}}{Δ {H}_{m , PEG} + Δ {H}_{f , PEG}} \times 100 \qquad ( 3 )$$

$${E}_{eff} = \frac{Δ {H}_{m , com}}{{x}_{PEG}} \qquad ( 4 )$$

where ΔHₘ is the latent heat, Tₘ is the melting temperature, ΔH_{f} is the latent heat of cooling, T_{f} is the freezing point, R is the impregnation ratio, φ=energy storage ability (capability), ΔT is the temperature difference due to super cooling, E is the energy storage efficiency, E_{ef} is the efficient energy per unit mass of PEG, and X_{PCM}=polymer weight fraction in PCM.

The Ni-BTC/PEG composite's thermal storage capacity shows that nearly all PEG molecules store/release energy effectively during the transition. Therefore, a high latent heat value of 156.0 J/g, compared to that of the other examined samples, was attained. Results of other ss-PCMs in Table 1 are relatively lower than values of the current invention. Even though many PCMs, both organic and inorganic, have a high latent heat, research has focused mostly on PCMs made of paraffin and PEG because of their operating temperature. The maximum value of the examined PCMs' high energy storage efficiency is 95.6%. Compared to previous studies listed in Table 1, the energy storage efficiencies of the samples analyzed in the current invention are more favorable. According to the freezing and melting temperature differences of PEG, Co-BTC/PEG, Ni-BTC/PEG, and Co—Ni-BTC/PEG, the extent of super cooling is 25.0° C., 20.1° C., 19.0° C., and 21.3° C., respectively. This result is supported by the greater freezing and melting latent temperatures of Ni-BTC/PEG. No vapor or gas formed during the melting cycle. Additionally, the freezing process does not result in cavities.

TABLE 1
Thermal activity of PEG and PEG-containing PCM composites
(Ni-BTC/PEG, Co-BTC/PEG and Co—Ni-BTC/PEG)

| | ΔHₘ | ΔH_{f} | Tₘ | T_{f} | ΔTₛ | R | Φ | E | E_{eff} |
|---|---|---|---|---|---|---|---|---|---|
| Sample | (J/g) | (J/g) | (° C.) | (° C.) | (° C.) | (%) | (%) | (%) | (J/g) |
| PEG | 189.6 | 170.1 | 63.0 | 38.0 | 25.0 | — | — | — | 189.6 |
| Ni-BTC/PEG 0.2:0.5 | 152.5 | 130.5 | 60.0 | 39.9 | 22.1 | 72.5 | 100.7 | 73.0 | 98.2 |
| Ni-BTC/PEG 0.20.7 | 156.0 | 137 | 59.0 | 39.0 | 19.0 | 85.0 | 99.4 | 95.6 | 99.8 |
| Ni-BTC/PEG 0.2:1.0 | 157.5 | 130.0 | 60.0 | 39.9 | 22.5 | 71.8 | 99.8 | 74.4 | 100.0 |
| Co-BTC/PEG 0.20.5 | 138 | 132 | 59.9 | 40 | 22 | 72.7 | 100.9 | 75.0 | 97.47 |
| Co-BTC/PEG 0.2:0.7 | 138.9 | 138 | 61 | 40 | 21 | 82.8 | 98.84 | 86.3 | 98.8 |
| Co-BTC/PEG 0.2:1.0 | 139 | 131.1 | 60 | 40.1 | 20 | 73.3 | 101.3 | 75.0 | 100 |
| Co—Ni-BTC/PEG 0.2:0.5 | 135 | 134 | 59.8 | 38.5 | 21.3 | 71.2 | 105.0 | 74.7 | 99.68 |
| Co—Ni-BTC/PEG 0.2:0.7 | 138.8 | 134.1 | 62.5 | 41.2 | 21.3 | 70.7 | 107 | 75.8 | 99.02 |
| Co—Ni-BTC/PEG 0.2:1.0 | 137 | 130.2 | 62 | 40 | 22 | 72.2 | 102.8 | 74.2 | 101 |
| Pure Paraffin* | 136.2 | 135.8 | 26.8 | 23.0 | 3.8 | — | — | — | — |
| EP/20% Paraffin* | 10.4 | 11.3 | 27.5 | 22.6 | 4.9 | 7.6 | 104.5 | 8.0 | — |
| EP/40% Paraffin* | 53.5 | 51.6 | 27.3 | 22.4 | 5.0 | 39.3 | 98.4 | 38.6 | — |
| EP/60% Paraffin* | 80.9 | 80.8 | 27.6 | 22.5 | 5.0 | 59.4 | 100.1 | 59.5 | — |
| EP/80% Paraffin* | 118.2 | 118 | 27.4 | 22.4 | 5.0 | 86.8 | 100.1 | 86.8 | — |
| Paraffin (RT27)** | 154 | — | 25.1 | 25 | 0.1 | — | — | — | — |
| RT27/EP** | 84 | — | 26.3 | 25.5 | 0.8 | 54.6 | — | — | — |
| RT27/EP/SL** | 51.6 | — | 26.3 | 25.8 | 0.5 | 33.5 | — | — | — |
| RT27/EP/SL/AL** | 50 | — | 26.1 | 25.3 | 0.8 | 32.5 | — | — | — |
| PEG6000*** | 185.3 | 187.1 | 61.8 | 36.2 | 25.6 | — | — | — | — |
| GNS/PEG*** | 176.9 | 178.8 | 60.5 | 37.3 | 23.2 | 95.5 | 100.1 | 95.5 | — |
| Ag/GNS/PEG (1)*** | 177.2 | 179.4 | 60.2 | 35.9 | 24.3 | 95.6 | 100.1 | 95.8 | — |
| Ag/GNS/PEG (2)*** | 173.3 | 175.8 | 60.3 | 35.6 | 24.7 | 93.5 | 100.2 | 93.7 | — |
| Ag/GNS/PEG (3)*** | 169.6 | 171.9 | 60.2 | 36 | 24.2 | 91.5 | 100.2 | 91.7 | — |
| Ag/GNS/PEG (4)*** | 166.1 | 167.8 | 60.3 | 36.1 | 24.2 | 89.6 | 100.0 | 89.7 | — |

*A. Karaipekli, A. Biçer, A. Sari, V. V. Tyagi, Thermal characteristics of expanded perlite/paraffin composite phase change material with enhanced thermal conductivity using carbon nanotubes, Energy Conversion and Management. 134 (2017) 373-381;
**Z. Lu, B. Xu, J. Zhang, Y. Zhu, G. Sun, Z. Li, Preparation and characterization of expanded perlite/paraffin composite as form-stable phase change material, Solar Energy. 108 (2014) 460-466; and
***Mekaddem, S. Ben Ali, M. Fois, A. Hannachi, Paraffin/expanded perlite/plaster as thermal energy storage composite, Energy Procedia. 157 (2019) 1118-1129; which are incorporated herein by reference in their entireties.
Uncertainties for the phase change temperature and latent heat were calculated using the average of three measurements, which were ±1.0° C. and ±5%, respectively.

### Example 12: Thermal Cycling of Ni-BTC/PEG

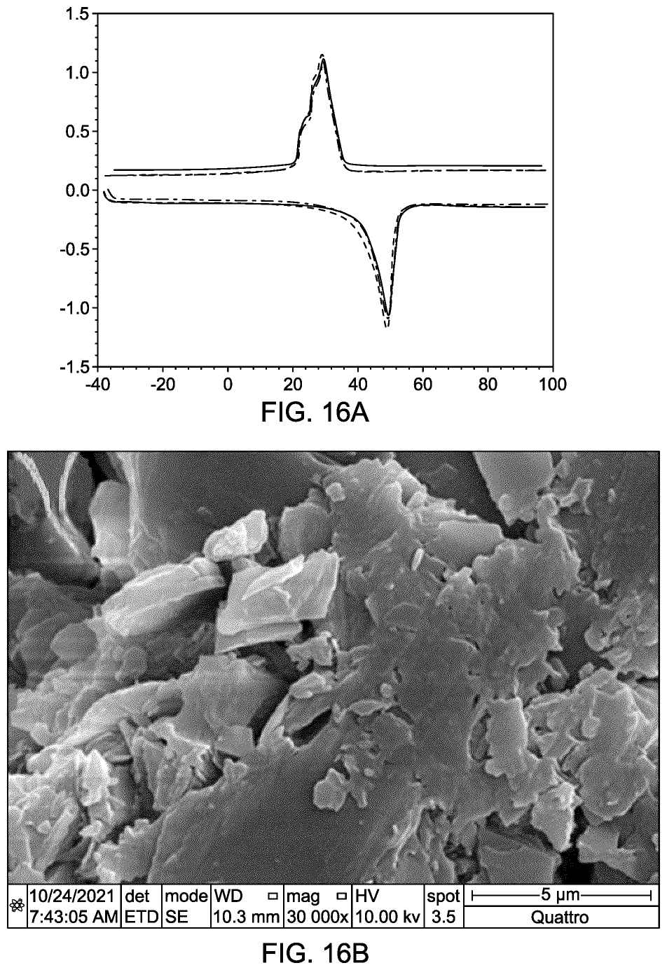

The thermal cycling behavior of Ni-BTC/PEG PCM is used in determining commercial viability. The Ni-BTC/PEG PCM maintained its thermal stability after undergoing 200 heat cycles. The DSC curves for Ni-BTC/PEG after 0 and 200 thermal cycles are shown in FIG. 16A. The exothermal and endothermal curves both exhibit negligible change with cycling, pointing to the composite's long cycle life and strong thermal reliability. The DSC results show that the Ni-BTC/PEG composite can maintain constant temperature and enthalpy phase transitions and, in applications involving repeated heating/cooling cycles at a constant temperature, the PCM of the current invention can be used to store and release latent heat. The FESEM image shows that even after 200 heat cycles, the sample still has its original structure (FIG. 16B). The thermal stability of PCM shows that surface tension forces and capillary action were used to incorporate liquid PEG into the matrix. Mesoporous and/or macro-porous structures permit PEG chains to penetrate the matrix even if micropores and/or nanopores can hinder this process. Because of the presence of the PEG, the formation of two types of pore design, as stated above in Ni-BTC/PEG (FIGS. 14A-14C), causes a rise in the latent heat of the PCM. After experiencing a reversible phase transition during cyclic heating and chilling trials, the Ni-BTC/PEG PCM keeps its form.

The Ni-BTC/PEG can maintain its structure even after being subjected to intense thermal cycling, as seen in the FE-SEM image taken after 200 cycles (FIG. 16B). Moreover, even after 200 cycles, no new peaks are observed in the DSC curves (FIG. 16A), and the positions of the peaks in the melting and freezing curves only vary slightly. The FESEM image demonstrates that the Ni-BTC and PEG particles are thoroughly combined, and the Ni-BTC/layered PEG's structure offers PEG support.

The quasi-uniform distribution of PEG in the shape-stabilized-PCM is supported by the fact that PEG fills the pores in the Ni-BTC network. When Ni-BTC/PEG is subjected to 200 heat cycles, the characteristic peaks in its FTIR spectrum remain unaltered, demonstrating the chemical stability of the compound's structure. This illustrates the structural and chemical stability of the Ni-BTC/PEG composite PCM.

### Example 13: Thermal Conductivity of PEG and PEG Containing Composites (Ni-BTC, Co-BTC and Co—Ni-BTC)

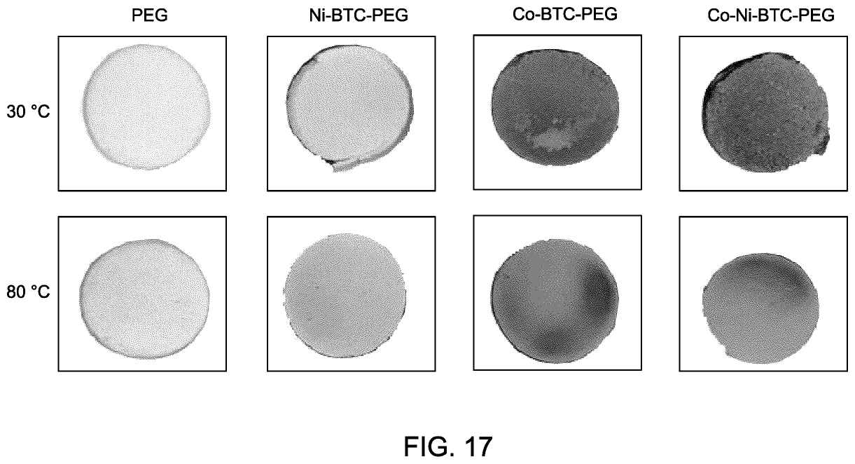

The thermal conductivity of the materials was measured by a TCi Conductivity Analyzer (received from Canada), which uses a modified transient plane source (MTPS) and the measurement method. A PCM's ability to store and discharge heat is improved by enhancing the nucleation kinetics, which depends on thermal conductivity. The supporting Ni matrix of the PCM can be credited with the Ni-BTC PCM's higher thermal conductivity. The PEG system can experience faster charging (melting) and discharging (freezing) because of Ni material's dense network of thermally conductive interfaces and efficient nucleation kinetics. The Ni-BTC supporting matrix is responsible for the PCM's effective nucleation kinetics, which is supported by the same freezing and melting characteristics discovered using DSC findings. Ni-BTC's distinctive hexagonal particle size [inset, FIG. 6B] may be a factor in the material's improved thermal conductivity. The loss of water during the heat treatment is attributed to what caused the green of Ni-BTC/PEG to turn pale, as well as the pink color of Co-BTC/PEG and Co—Ni-BTC/PEG samples, respectively (FIG. 17). The higher density of Ni-BTC/PEG is thought to be responsible for its improved thermal conductivity due to heat transfer occurring more rapidly at higher densities. As a result, Ni-BTC enhances thermal conductivity (Table 2) while still maintaining the compatibility, thermal stability, and thermal energy storage (TES) properties of PEG as a PCM. The composite systems show a partial loss of both the latent heat of freezing and melting due to the presence of the matrix. The three samples' respective impregnation ratios (R) are 78.48%, 74.79%, and 68.28%. The composites' heterogeneity, which results in less-than-ideal PEG mixing and/or penetration, explains these observations.

TABLE 2
Thermal conductivity of PEG, and PEG containing
Ni-BTC, Co-BTC and Co—Ni-BTC composite

| Material | Thermal conductivity (W/m · K) |
|---|---|
| PEG | 0.230 ± 0.03 |
| Co-BTC/PEG | 0.2806 ± 0.04 |
| Ni-BTC/PEG | 0.3186 ± 0.02 |
| Co—Ni-BTC/PEG | 0.2628 ± 0.04 |
| EP* | 0.05 |
| Eicosane (C20)* | 0.22 |
| EP/C20* | 0.15 |
| EP/C20/0.3% CNT* | 0.19 |
| EP/C20/0.5% CNT* | 0.24 |
| EP/C20/1% CNT* | 0.32 |

*A. Karaipekli, A. Biçer, A. Sar1, V. V. Tyagi, Thermal characteristics of expanded perlite/paraffin composite phase change material with enhanced thermal conductivity using carbon nanotubes, Energy Conversion and Management. 134 (2017) 373-381

The images reveal that Ni-BTC/PEG, Co-BTC/PEG, and Co—Ni-BTC/PEG (FIG. 17) composites do not exhibit visible melting during heating at 80° C. for 10 minutes, indicating the absence of PEG leakage. It is noteworthy that PEG begins to melt at 80° C. The color change rates of the composites differ, suggesting distinct heat transfer rates. After ten seconds, Ni-BTC/PEG exhibits the fastest color change, reflecting the highest thermal conductivity. The filter paper was thoroughly examined after each sample was removed from it, confirming the absence of PEG leakage. This behavior can be attributed to capillary action and surface tension, which are governed by the porous structure, including nanopores, of Ni-BTC, limiting the leakage of PEG. The observed results suggest that the enhanced thermal conductivity of Ni-BTC/PEG (Table 2) is likely due to its higher density, which facilitates quicker heat transmission, while also retaining the PCM's compatibility, thermal stability, and TES properties; however, the presence of the matrix may lead to a partial loss of both the latent heat of freezing and the latent heat of melting.

### Example 14: Solar to Thermal Energy Storage Efficiency of PCM

As can be seen from the PCM's improved optical characteristics, the Ni-BTC MOF in the Ni-BTC/PEG PCM enables simultaneous solar-to-thermal energy conversion and thermal energy storage. The Ni-BTC nanoparticles help PEG absorb more light throughout the entire visible spectrum, increasing its absorption at roughly 300 nm. The improved full-band selective absorption is principally responsible for the Ni-BTC composite's photothermal conversion efficiency. Based on the UV-vis absorption spectra in the visible range, the solar-to-thermal energy storage efficiency of a PEG/graphene PCM was recently estimated using Eq. 5 [L. Zhang, P. Zhang, F. Wang, M. Kang, R. Li, Y. Mou, Y. Huang, Phase change materials based on polyethylene glycol supported by graphene-based mesoporous silica sheets, Applied Thermal Engineering. 101 (2016) 217-223, which is incorporated herein by reference in its entirety]. The Ni-BTC/PEG PCM's optical characteristics are greater than those of Ni-BTC alone. The UV-visible absorption spectra of PEG alone and Ni-BTC/PEG PCM were compared for additional confirmation, and it was discovered that Ni-BTC/PEG PCM had a greater absorption than PEG alone. The good optical characteristics and high value of latent heat of the material are thought to responsible for the improved solar energy conversion into thermal energy and energy storage capacity of the PCM, determined using this method. Moreover, Ni-BTC/PEG's light absorption spectra, as recorded in the full visible area, are wider than PEG's alone. To investigate the conversion of solar energy into thermal energy by PEG 6000 and Ni-BTC/PEG, and to evaluate the capacity of Ni-BTC/PEG for this purpose, temperature recorders were implanted beneath solar simulators. The high activity of Ni-BTC/PEG and/or PEG, which can be employed as a molecular stove and in photon emission, can be attributed for the increase in temperature shown. Infrared light causes PEG to become hotter when it is exposed to solar irradiation. After prolonged exposure to radiation, there was an optimal value observed, indicating the conversion of solar energy to thermal energy through a phase change. During the cooling process, a cooling stage was observed, which is attributed to the release of stored energy.

$$η = m Δ H / IS ( {T}_{t} - {T}_{f} ) \qquad ( 5 )$$

In this equation, m represents the weight of the sample, and AH represents the enthalpy of the melting phase change. I and S refer to the optical power density and radiated field, respectively, while Tₜ and T_{f} correspond to the starting and ending phase transition times.

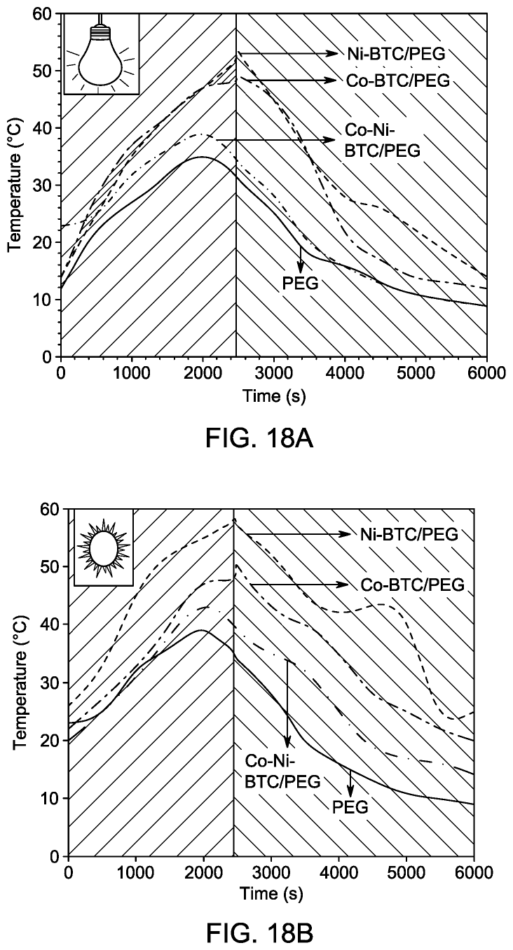

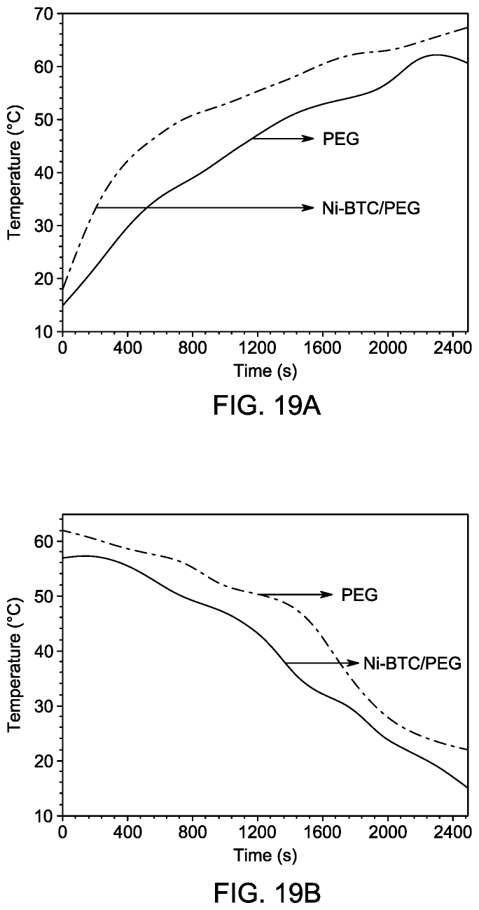

Ni-BTC/PEG PCM has a solar-to-thermal energy storage efficiency (η) of 72.2%. These results show good efficiency in photothermal energy storage compared to previously reported PCMs made of carbon-containing materials. To assess and estimate the performance of the Ni-BTC/PEG PCM for real-world applications, sunlight exposure was used. Under prolonged exposure to solar radiation, the temperature rose, and an ideal value for temperature boosting was discovered. When sunlight was blocked during the cooling process, an improved value for temperature reduction was also attained (FIG. 18A & FIG. 18B). Using phase transition, this system can transfer solar energy into heat energy and store energy. The PCM created has a high thermal capacity to satisfy the demands of real-world applications, according to the high enthalpy of Ni-BTC/PEG. Also, the heating and chilling temperatures on the plateau are compatible with the melting and freezing temperatures in the solar-to-thermal energy conversion curves (FIG. 19A & FIG. 19B). The solar-to-heat conversion efficiency drops by less than 0.63% after 200 cycles.

Three types of metal-BTC containing Ni, Co, and Co—Ni were prepared using the hydrothermal technique, and their suitability as matrices for housing the PEG polymer was explored. Efficient matrices containing BTC with cobalt and nickel were prepared as air-stable, easily synthesized, and with low-cost materials that could be synthesized under hydrothermal conditions for thermal energy storage. The phase change material of the current disclosure demonstrated the utility of molecular chemistry to synthesize thermally stable open and firm networks that allow selective inclusion and encapsulation of phase change materials.

Among the three samples, the Ni-BTC/PEG sample showed the best performance for energy storage, with a latent heat of 156 J/g, due to the presence of high densities of hydrogen bonds and/or OH groups. The recyclability results of the Ni-BTC/PEG PCM displayed a low supercooling value. The developed PCM can store and release latent heat in applications involving repeated heating/cooling cycles at a constant temperature. Ni-BTC/PEG PCM maintained its capability to store and supply energy without significant changes even after repeated thermal heating and cooling cycles.

Numerous modifications and variations of the present disclosure are possible in light of the above teachings. It is therefore to be understood that within the scope of the appended claims, the invention may be practiced otherwise than as specifically described herein.

1. A phase-change material (PCM), comprising:
a metal selected from a group consisting of cobalt and nickel,
reacted units of 1,3,5-benzenetricarboxylic acid,
wherein the metal and the reacted units of the carboxylic acid form a metal-organic framework,
a polyethylene glycol,
wherein a weight ratio of the metal organic framework to the polyethylene glycol is from 10:1 to 1:10,
wherein the polyethylene glycol is present within a matrix of the metal-organic framework,
wherein the phase-change material is in the form of agglomerated layers of wave-like sheets.

2. The phase-change material of claim 1, wherein the polyethylene glycol is polyethylene glycol 6000.

3. The phase-change material of claim 1, wherein the agglomerated layers of wave-like sheets have microcracks with a length of 1 to 50 μm.

4. The phase-change material of claim 1, wherein the agglomerated layers of wave-like sheets have one or more flaked edges.

5. The phase-change material of claim 1, wherein 60 to 90 wt. % of the polyethylene glycol is present in the matrix of the metal-organic framework based on a total weight of the polyethylene glycol in the phase-change material.

6. The phase-change material of claim 1, wherein the metal-organic framework comprises carbon in an amount of 50 to 70 atomic percent, oxygen in an amount of 25 to 45 atomic percent, and the metal in an amount of 1 to 5 atomic percent based on a total atom count of the metal-organic framework.

7. The phase-change material of claim 1, wherein the metal is cobalt and the metal-organic framework has a Brunauer-Emmett-Teller specific surface area of 250 to 350 m²/g.

8. The phase-change material of claim 1, wherein the metal is nickel and the metal-organic framework has a Brunauer-Emmett-Teller specific surface area of 800 to 900 m²/g.

9. The phase-change material of claim 1, wherein the metal is cobalt and nickel and the metal-organic framework has a Brunauer-Emmett-Teller specific surface area of 550 to 650 m²/g.

10. The phase-change material of claim 1, wherein the metal is cobalt and the metal-organic framework has a micropore volume of 0.7000 to 0.7500 cm²/g.

11. The phase-change material of claim 1, wherein the metal is nickel and the metal-organic framework has a micropore volume of 0.2500 to 0.3000 cm²/g.

12. The phase-change material of claim 1, wherein the metal is cobalt and nickel and the metal-organic framework has a micropore volume of 0.2000 to 0.2500 cm²/g.

13. The phase-change material of claim 1, wherein the phase-change material has a thermal stability of 200 to 400° C. based on thermogravimetric analysis.

14. The phase-change material of claim 1, wherein the metal is nickel and the phase-change material has a melting latent heat value of 150 to 160 J/g.

15. The phase-change material of claim 1, wherein the metal is nickel and the phase-change material has a freezing latent heat value of 125 to 140 J/g.

16. The phase-change material of claim 1, wherein the metal is cobalt and the phase-change material has a melting latent heat value of 135 to 140 J/g.

17. The phase-change material of claim 1, wherein the metal is nickel and the metal-organic framework has a solar-to-thermal energy storage efficiency of 70 to 75 percent.

18. The phase-change material of claim 1, wherein the metal is nickel and the phase-change material has a thermal stability of at least 200 differential scanning calorimetry melting and freezing cycles, wherein the thermal stability is based on a solar-to-thermal conversion value and the solar-to-thermal conversion value is 0.5 to 1.0 percent less than an initial solar-to-thermal conversion value.

19. The phase-change material of claim 1, wherein the phase-change material has a super cooling value of 18 to 23° C.

20. The phase-change material of claim 1, wherein the phase-change material has a thermal conductivity of 0.2200 to 0.3500 W m⁻¹ K⁻¹.
